(19) United States
(12) Patent Application Publication
(10) Pub. No.: US 2019/0311237 A1
(43) Pub. Date: Oct. 10, 2019

(54) METHOD AND SYSTEM FOR PROVIDING AUTHENTICATED PRODUCT INFORMATION TO DISTRIBUTED DEVICES

(71) Applicant: Tag Talk Inc., San Jose, CA (US)

(72) Inventors: Qing Li, San Jose, CA (US); Ling-Yao Chen, Los Angeles, CA (US); Ling-Chieh Chen, Los Angeles, CA (US)

(21) Appl. No.: 15/947,347

(22) Filed: Apr. 6, 2018

(51) Int. Cl. G06K 19/07; G06F 21/30; H04L 29/06; G06K 19/06

(52) U.S. Cl. CPC G06K 19/0725; G06K 19/06037; H04L 63/08; G06F 21/30

(57) ABSTRACT

The present teaching relates to method and system for providing information about a product. The method includes receiving, by a device of a user via a wireless connection when the device is near the product, a unique identifier from a near field communication (NFC) chip embedded in a tag attached to the product. The tag is constructed to embed an antenna, which breaks down upon a force being applied to tear the tag, and disables communication between the NFC chip and the device. The method forwards the unique identifier to a server that stores information about the product, and receives from the server the information about the product. The received information about the product is presented on the device to the user.

### BACKGROUND

### 1. Technical Field

The present teaching generally relates to authentication. More specifically, the present teaching relates to anti-counterfeit and derivation of relevant market distribution information.

### 2. Technical Background

With recent technological advancement in ubiquitous wireless network and smart devices, the world is increasingly connected. Such connections have led to tremendous development of different applications that allow the users to do more and more things across the network at any time and at where.

While such networked applications have provide benefits to many businesses, the Internet phenomenon has not created as much advantage to some traditional business operations. One example is the authentication of physical goods when such goods are distributed. Such goods include foods, consumer products, etc. Counterfeit activities occur in many parts of the world which presents a serious challenge to the makers of the products that are counterfeited. Counterfeit is especially a problem for many name brand products, such as Louis Vuitton bags, wines, shoes, etc. Because such products are shipped to many countries in the world and counterfeit activities may or may not occur in the countries the authenticate products are shipped, the makers of authenticate products have not been able to track, let alone, enforce their rights wherever counterfeit occurs. Thus, there is a need to develop a solution for authenticating various products so that counterfeit information can be gathered and provide to makers of such products.

### SUMMARY

The teachings disclosed herein relate to methods, systems, and programming for online authentication services. More particularly, the present teaching relates to anti-counterfeit and derivation of relevant market distribution information.

In one example, a method for providing information of a product is disclosed. The method can be implemented on a computer having at least one processor, a storage, and a communication platform. The method includes the steps of receiving, by a device of a user via a wireless connection when the device is near the product, a unique identifier from a near field communication (NFC) chip embedded in a tag attached to the product. The tag is constructed to embed an antenna, which breaks down upon a force being applied to tear the tag, and disables communication between the NFC chip and the device. Further, the method includes forwarding the unique identifier to a server that stores information about the product, and receiving from the server the information about the product. The received information about the product is presented on the device to the user.

In a different example, there is disclosed a method implemented on a computer having at least one processor, a storage, and a communication platform for providing information about a product. The method includes the steps of receiving a unique identifier from a device, which obtains the unique identifier from a near field communication (NFC) chip embedded in a tag attached to the product. The tag has a multi-layered construct and embeds an antenna, which breaks down upon a force being applied to tear the tag, preventing the NFC chip from communicating via a wireless connection. The method includes receiving from the device additional information associated with the device, and retrieves, based on the unique identifier, information previously stored about the product. Information about the product is sent to the device, and the information associated with the device in connection with the information about the product is recorded.

In one example, there is disclosed an apparatus comprising a product and a tag attached to the product. The tag has a multi-layered construct with an embedded antenna and a near field communication (NFC) chip that is configured to communicate through the antenna. The antenna breaks down upon a force being applied to tear the tag, preventing the NFC chip from the communication. The NFC chip stores a plurality pieces of information and includes a processor configured to transmit a unique identifier stored therein to a device via a wireless connection when the device is nearby, receive, via the wireless connection, a passcode from the device, and transmit an authentication code stored therein when the received passcode matches a corresponding passcode stored.

Other concepts relate to software for implementing the present teaching on developing a virtual agent. A software product, in accord with this concept, includes at least one machine-readable non-transitory medium and information carried by the medium. The information carried by the medium may be executable program code data, parameters in association with the executable program code, and/or information related to the present teachings disclosed herein.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A shows a schematic of authenticating an exemplary product via an authentication tag in connection with a cloud server, according to an embodiment of the present teaching;

FIG. 1B illustrates exemplary types of products that may be authenticated as to the true makers in accordance with the present teaching;

FIG. 2A illustrates functional content within an authentication tag, in accordance with an embodiment of the present teaching;

FIG. 2B illustrates an exemplary design of an authentication tag, in accordance with an embodiment of the present teaching;

FIG. 3 illustrates an exemplary physical construct of an authentication tag, in accordance with an embodiment of the present teaching;

FIG. 4A illustrates an exemplary physical construct of the authentication tag AuthTag 110, in accordance with an embodiment of the present teaching;

FIG. 4B shows an exemplary assembly line 480 for releasing AuthTags from a release paper roll 480 and attaching each of the released AuthTags to a single product (a bottle of wine);

FIG. 5 depicts an exemplary high level system schematic of writing authentication information into an authentication tag, according to an embodiment of the present teaching;

FIG. 6 is a flowchart of an exemplary process of writing authentication information into an authentication tag, according to an embodiment of the present teaching;

FIG. 7 depicts an exemplary high level system schematic of activating an NFC enabled application, according to an embodiment of the present teaching;

FIG. 8 is a flowchart of an exemplary process of activating an NFC enabled application, according to an embodiment of the present teaching;

FIG. 9 depicts an exemplary high level system construct of authenticating a product via an NFC enabled application in connection with a cloud server, according to an embodiment of the present teaching;

FIG. 10 depicts an exemplary protocol scheme 1 of authenticating a product via an NFC enabled application in connection with a cloud server, according to an embodiment of the present teaching

FIGS. 11A-11C provide flowcharts of exemplary processes of the NFC chip 230, the NFC-enabled authentication application 720, and the cloud server 140, according to the embodiments of the present teaching;

FIG. 12 depicts an exemplary high level system diagram of a processor in an authentication tag, according to an embodiment of the present teaching;

FIG. 13 is a flowchart of an exemplary process of a processor embedded in an authentication tag to write authentication information into the authentication tag in connection with a cloud server, according to an embodiment of the present teaching;

FIG. 14 is a flowchart of an exemplary process of a processor embedded in an authentication tag to authenticate a product in connection with a cloud server, according to an embodiment of the present teaching;

FIG. 15 depicts an exemplary high level system diagram of a cloud server that, according to an embodiment of the present teaching;

FIG. 16 is a flowchart of an exemplary process of a cloud server working with a processor embedded in an authentication tag to write authentication information into the authentication tag, according to an embodiment of the present teaching;

FIG. 17 is a flowchart of an exemplary process of a cloud server working with a processor embedded in an authentication tag to authenticate a product, according to an embodiment of the present teaching;

FIG. 18 illustrates exemplary types of information that can be collected via an authentication process, according to an embodiment of the present teaching;

FIG. 19 is a flowchart of an exemplary process for collecting and analyzing distribution information related to products via authentication process, according to an embodiment of the present teaching;

FIG. 20 depicts the architecture of a mobile device which can be used to implement a specialized system incorporating the present teaching;

FIG. 21 depicts the architecture of a computer which can be used to implement a specialized system incorporating the present teaching;

FIG. 22 illustrates exemplary types of information that may be collected via the authentication process disclosed, according to an embodiment of the present teaching;

FIG. 23 illustrates an example of such a map with different regions identified representing presence of a product, according to an embodiment of the present teaching;

FIG. 24 is a flowchart of an exemplary process for the third portion of the cloud server 140, according to an embodiment of the present teaching;

FIGS. 25A-25B depict an exemplary embodiment of an anti-tempering mechanism for an example product, according to an embodiment of the present teaching;

FIG. 26 depicts the architecture of a mobile device which can be used to realize a specialized system implementing the present teaching; and

FIG. 27 depicts the architecture of a computing device which can be used to realize a specialized system implementing the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

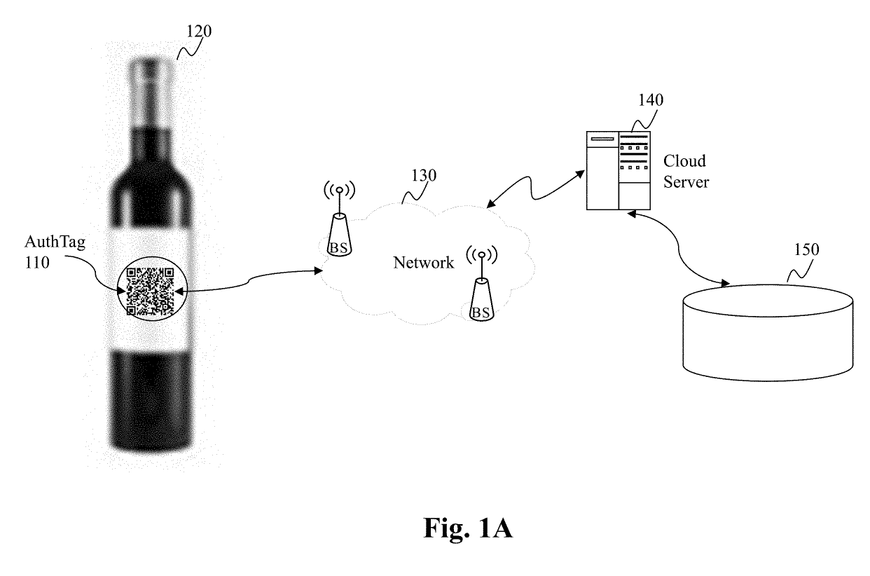

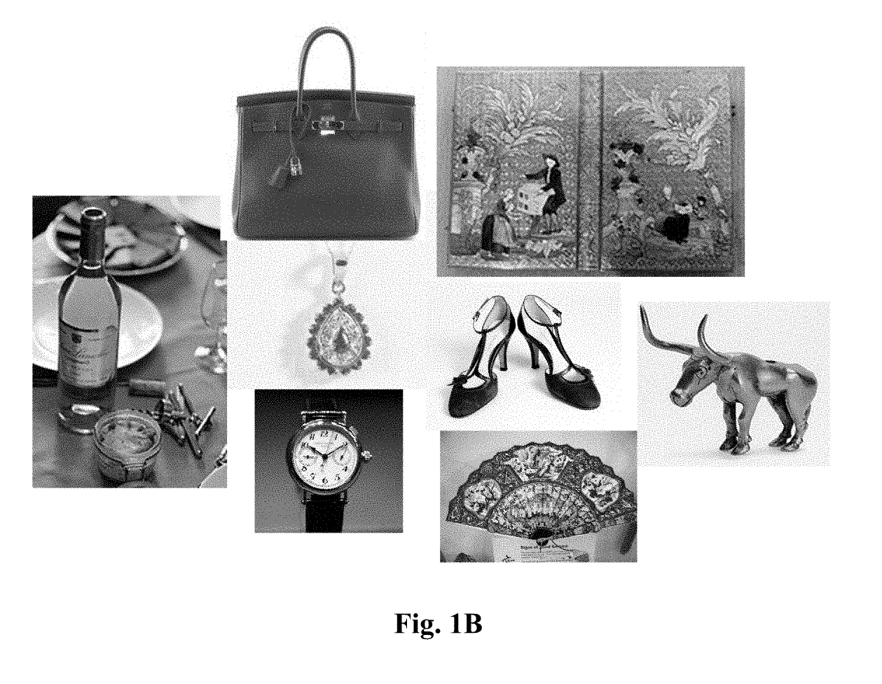

The present disclosure generally relates to systems, methods, medium, and other implementations for authenticating products distributed into the marketplace and collecting market information via the authenticating process as well as the effective use thereof. FIG. 1A shows a schematic of authenticating an exemplary product via an authentication tag in connection with a cloud server, according to an embodiment of the present teaching. In this scheme, an authentication tag AuthTag 110 is adhered to an exemplary product, a bottle of wine 120. The AuthTag 110 is used to be connected, via a network 130, to a cloud server 140 so that the product 120 can be authenticated based on information stored in a server database 150 associated with the cloud server 140. It is understood that the product being authenticated can be any product, some of which are illustrated in FIG. 1B, which illustrates exemplary types of products that may be authenticated as to the true makers in accordance with the present teaching. Products that may be authenticated as to their true origin may include, but not limited to, food items such as wine, luxury goods such as bags, jewelries, watches, shoes, paintings, antiques, and other artistic artifacts.

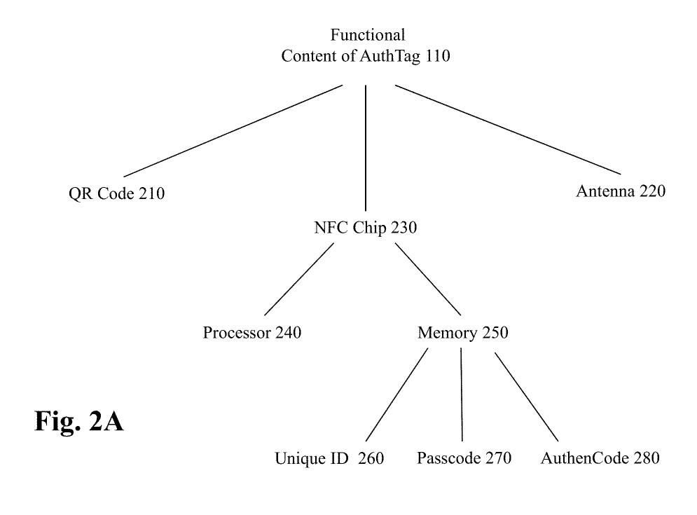

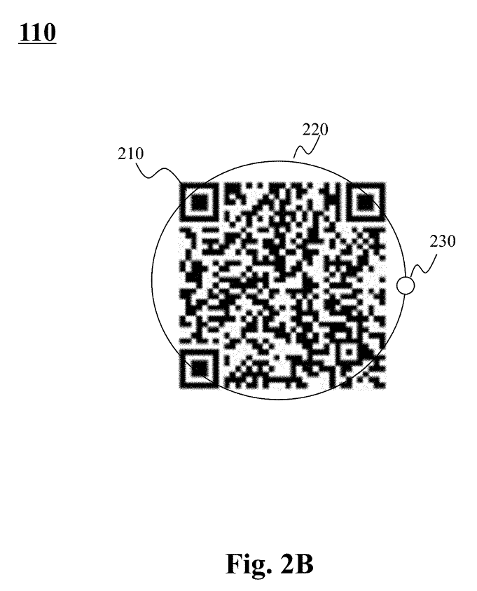

FIG. 2A illustrates functional content within the authentication tag 110, in accordance with an embodiment of the present teaching. As illustrated, the functional aspects of the AuthTag 110 may include a QR code 210, an antenna 220, and an NFC chip 230 that is connected to the antenna 220 for communication purposes. The physical construct of the AuthTag 110 including these three parts is shown in FIG. 2B. The AuthTag 110 has the QR code 210 on the surface of the AuthTag 110. The antenna 220 may be configured to be underneath the QR code 210 and be partially occluded by the QR code 210. Connected with the antenna 220 is the NFC chip 230, which is connected to the antenna for wireless communications needed for the disclosed authentication in accordance with the present teaching.

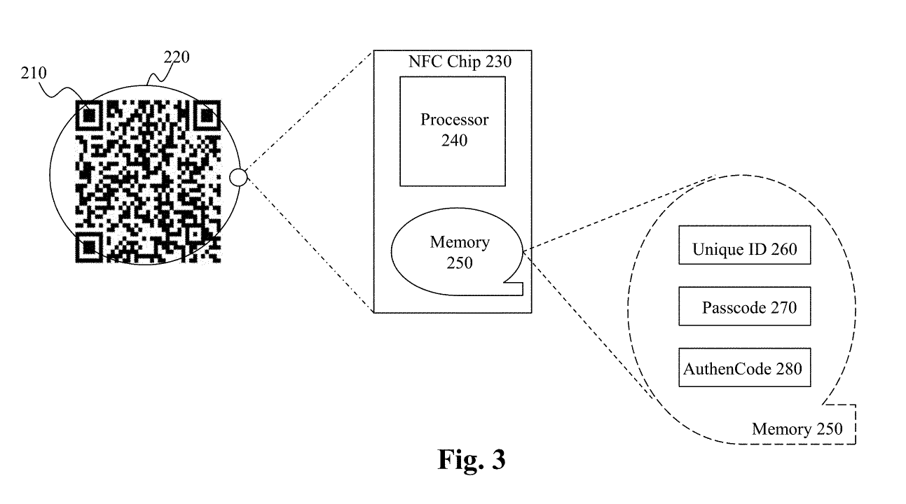

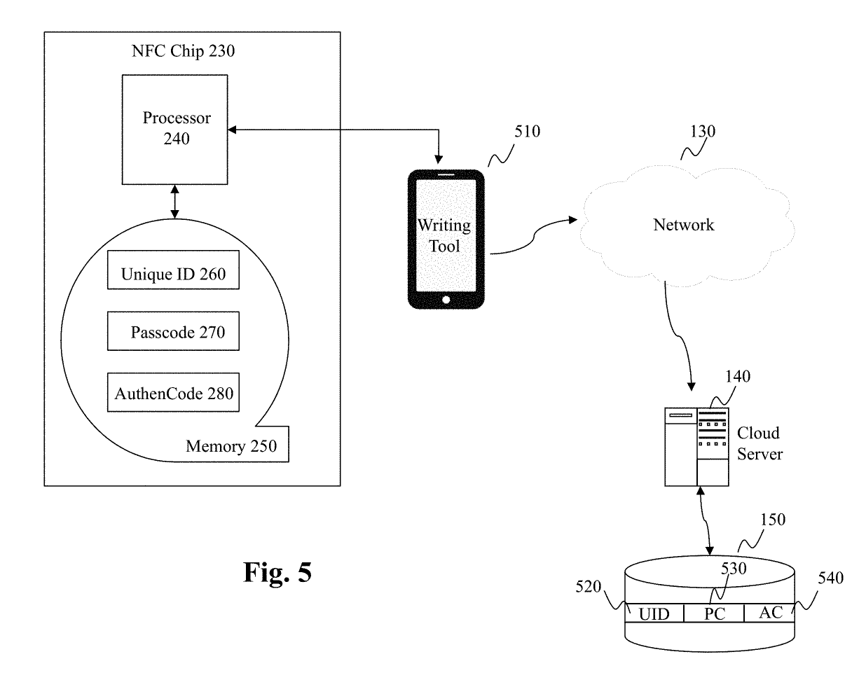

Back to FIG. 2A, the NFC chip 230 may be further constructed to include computational capabilities with a processor 240 and a memory 250. This is further shown in FIG. 3, where the NFC chip embedded in the AuthTag 110 comprises the processor 240 and the memory 250. The processor may be configured to facilitate the authentication by working, in connection with the memory, to write necessary authentication information into the memory and, at the time of authenticating, to authenticate in connection with the cloud server 140 to verify that the authentication information stored in the AuthTag 110 is consistent with the corresponding information stored in the cloud server 140. This is further disclosed in detail with reference to FIGS. 5-14.

The memory 250 in the NFC chip 230 may be used to store necessary authentication information to be used for authenticating the true maker of the product. As illustrated in FIG. 2A and FIG. 3, the memory in the NFC chip 230 may store a unique ID 260, a passcode 270, and an AuthenCode 280. The use of the content stored in the memory 250 for authentication is disclosed in more detail with reference to FIGS. 5-14.

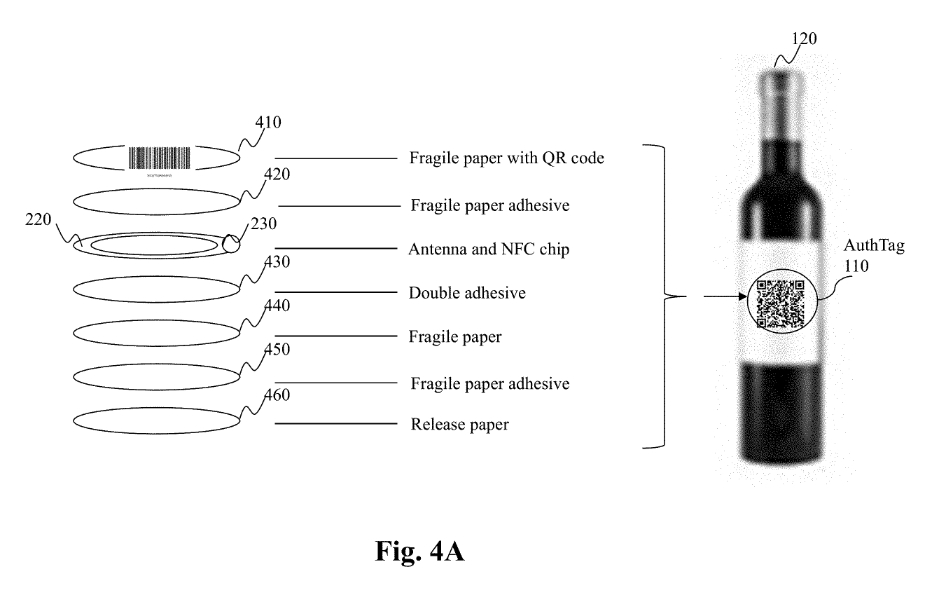

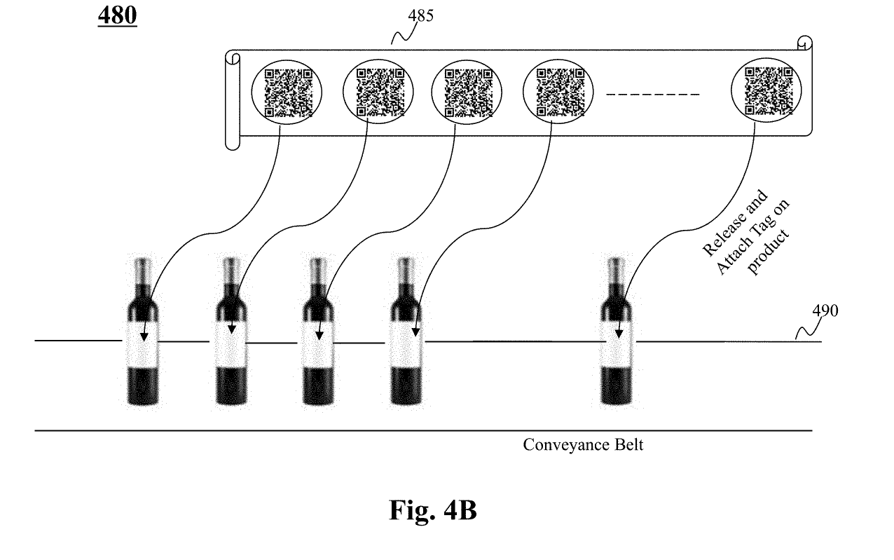

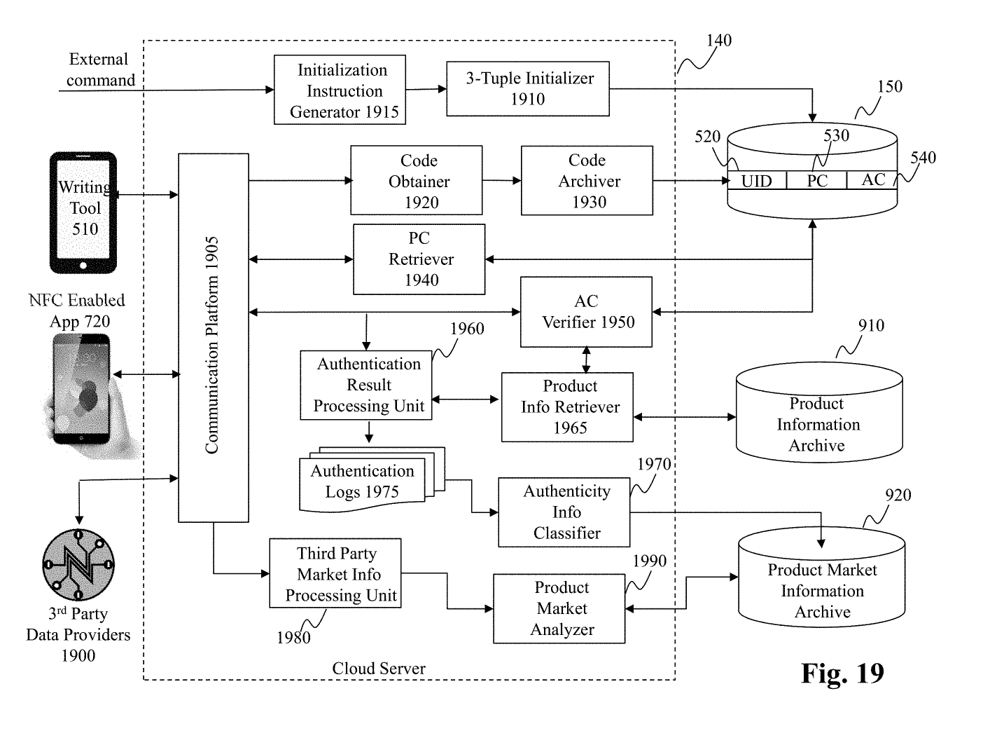

FIG. 4A illustrates an exemplary physical construct of the authentication tag AuthTag 110, in accordance with an embodiment of the present teaching. For preventing counterfeiters from peeling off an AuthTag 110 adhere to a product. In some industry such as wine industry, counterfeiters have been open the authenticate bottles of wines and filled with counterfeiter wine of lesser quality or even harmful products such as the ones manufactured using artificial chemicals. An anti-tempering mechanism may also be introduced to the AuthTag 110 so that the act of opening the bottle of wine may cause self-destruction of the AuthTag 110 to make it impossible to authenticate. Details about the anti-tempering mechanism is disclosed with reference to FIGS. 19-21.

The exemplary physical construct of the AuthTag 110 depicted in FIG. 4A shows that there are a number of layers of materials that comprise the AuthTag 110. For example, in FIG. 4A, there are seven layers, which include a first layer 410 which is a fragile paper with the QR code 210 thereon, a second layer 420 which corresponds to fragile paper adhesive, a third layer which includes both the antenna 220 and the embedded NFC chip 230, a fourth layer 430 which corresponds to a double adhesive layer, a fifth layer 440 which is a fragile paper layer, a sixth layer 450 that is again a fragile paper adhesive layer, and a seventh layer 460 that is a release paper. The construct of the AuthTag 110 may be such that it is durable enough to sustain the pressure and stress of the manufacturing process and the process of adhering the tag onto the product. However, it is also fragile at the same time against peeling so that when the tag is peeled, it renders the tag completely non-functional. To achieve these requirements, different layers use fragile papers.

Each layer of the construct of the AuthTag 110 is provided to achieve certain function. The first layer 410 corresponds to a fragile paper with the QR code 210 provided thereon so that the QR code 210 may be read contactlessly. Underneath the first layer 410, the second layer 420 corresponds to an adhesive layer that adheres to the first layer 410. This fragile paper adhesive layer 420 adheres to the first layer 410. The adhesive used for the second layer 420 may be selected suitable for fragile paper. The third layer corresponds to the antenna 220 which may be enclosed in a shape that may be a circle, an ellipse, or any other shape determined based on the specific application. The fourth layer 430 is a double adhesive layer with adhesives provided on both sides. As the antenna 220 is usually thin, when it is in-between the second and the fourth layers, when one (upper) side of the double adhesive layer 430 adheres to one (lower) side of the second layer fragile paper adhesive layer 420, not only the second and fourth layers are glued together, the antenna 220 may also be glued in-between like a sandwich. The other (lower) side of the fourth layer (double adhesive layer 430) is glued to the fifth layer 440, which is another layer of fragile paper. Finally, the fragile paper at the fifth layer 440 is glued to the seventh layer of release paper via the fragile paper adhesive at the sixth layer. The release paper is provided so that a tag can be released from a release paper roll having multiple AuthTags stuck thereon.

FIG. 4B shows an exemplary assembly line 480 for releasing AuthTags from a release paper roll 480 and attaching each of the released AuthTags to a single product (a bottle of wine). In operation of the assembly line 480, the actions of release the AuthTags from the paper roll 480 and placing on products may be performed automatically. As illustrated, the assembly line 480 may comprise a release paper roll 485, a conveyance belt with a stream of products (e.g., wine bottles) placed thereon, and some automatic mechanism(s) such as industrial robots (not shown) that are designed to function to peel off (release) one AuthTag from the paper roll 480 at a time and attach the released AuthTag on a designated spot of a product while the product passes with the movement of the conveyance belt.

FIG. 5 depicts an exemplary high level system schematic of writing authentication information into an authentication tag, according to an embodiment of the present teaching. As discussed herein, the memory 250 in the NFC chip 230 of an AuthTag 110 provides storage for a number of authentication related codes, including a unique ID 260, a passcode 270, and an AuthenCode 280. In some embodiments, the Unique ID 260 is provided when the NFC chip 230 is manufactured and the passcode 270 and the AuthenCode 280 are written into the memory 250 subsequently in coordination with the cloud server 140 and the server database 150. In such embodiments, the Unique ID 260 written into each NFC chip 230 may be ensured of uniqueness. In other embodiments, the Unique ID 260 may also be written into the NFC chip 230 subsequent to the NFC chip has been manufactured.

To write passcode 270 and AuthenCode 280 into the NFC chip 230 to facilitate authentication, a writing tool 510 is deployed by, e.g., a manufacturer of the underlying products being protected against counterfeit. The writing tool 510 may be a handheld device that is capable of communicating with the cloud server 140 via the network 130. The writing tool 510 may also be configured to be able to communicate with the processor 240 in the NFC chip 230 so perform needed writing operations. As shown, each NFC chip 230 stores a 3-tuple {Unique ID, passcode, AuthenCode}. For each 3-tuple in any NFC chip, there is a corresponding 3-tuple {UID, PC, AC} (520, 530, and 540, respectively) stored in the server database 150. Such a correspondence is what enables the authentication scheme described herein. In the embodiments where Unique ID is written into the NFC chip during manufacturing the NFC chip, each Unique ID written into an NFC chip is provided to the cloud server 140 so that the cloud server 140 stores each Unique ID as UID into the server database 150.

The writing tool 510 may be deployed on an NFC-enabled device so that it is capable of communicating with the NFC chip in an AuthTag. In some embodiments, such an NFC-enabled device may be a handheld device such as a smart phone or any other general or special purpose device, which can operate, e.g., wirelessly. In some embodiments, the writing tool 510 may be deployed as an application on such an NFC-enabled device and can be installed on the device or downloaded from a source of applications via the network 130. The writing tool 510 itself may be authenticated. The writing tool 510 may be configured to communicate with the processor 240 of the NFC chip 230 and the cloud server 140 to ensure consistent 3-tuples in both the NFC chip 230 and the server database 150.

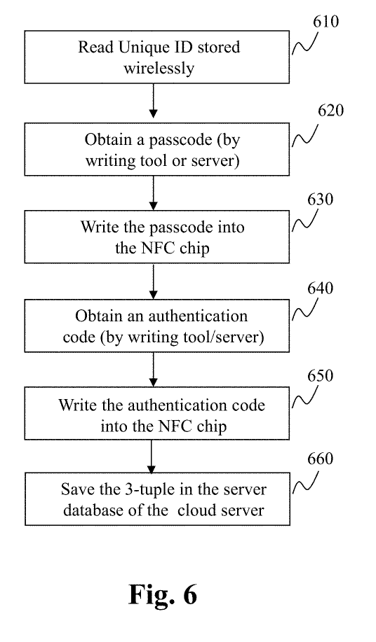

In operation, when the writing tool 510 is in proximity with the NFC chip 230, the writing tool 510 may be activated to carry out a sequence of operations. FIG. 6 is a flowchart of an exemplary process of the writing tool 510 writing authentication information into an authentication tag, according to an embodiment of the present teaching. Once activated, the writing tool 510 reads first, at 610, the Unique ID 260 stored in the NFC chip 230. Based on the Unique ID 260, a passcode 270 is obtained at 620. The passcode 270 may be obtained in different ways. In some embodiments, the passcode 270 is generated by the writing tool 510 based on certain algorithm. For example, the writing tool 510 may be configured to generate the passcode 270 based on an SHA algorithm. The passcode 270 may also be generated using other types of algorithms. In alternative embodiments, the passcode 270 may be generated by the cloud server 140, upon receiving the Unique ID 260 read from the NFC chip 230. In this case, the cloud server 140 may generate the passcode 270 based on some algorithm such as SHA algorithm. The generated passcode 270 is then sent to the writing tool 510. In either situation, the writing tool 510 obtains, as at step 620, a passcode.

The writing tool 510 then communicates with the processor 240 to write, at 630, the passcode 270 into the NFC chip 230. The writing tool 510 then obtains, at 640, an AuthenCode 280 and writes, at 650, the AuthenCode 280 into the NFC chip via the processor 240. The AuthenCode 280 may also be generated by either the writing tool 510 or by the cloud server 140 based on, e.g., the passcode 270 previously generated. The generation of the AuthenCode 280 may also be based on some algorithm such as SHA algorithm. The writing process ensures that the 3-tuple {Unique ID, passcode, AuthenCode} stored in the NFC chip 230 are the same as the 3-tuple {UID, PC, AC} stored in the server database 150. To achieve that, when the generation of the passcode 270 and AuthenCode 280 is performed by the writing tool 510, such passcode 270 and AuthenCode 280 as saved in the NFC chip 230 will be saved, at 660, into the sever database 150 at the cloud server 140. If the passcode 270 and the AuthenCode 280 are generated by the cloud server 140, the cloud server 140 saves, after the generation, these codes into the server database 150 to keep it consistent with what is saved in the NFC chip 230.

The cloud server 140 may optionally correspond each AuthTag with a type of product and such correspondence may enable the cloud server 140 to retrieve relevant product information and send to a consumer when the consumer's product is successfully authenticated. Product information may also be stored in the server database 150 and may be cross referenced with respect to stored 3-tuples in the server.

Depending on the configuration or application needs, the writing of the 3-tuple {Unique ID, Passcode, AuthenCode} may be done either before or after the AuthTag 110 is attached to each product. Similarly, if the passcodes and AuthenCodes are generated by the cloud server 140, such codes may be generated before or after the AuthTags are attached to the products.

The consistently stored 3-tuples in both NFC chips on products and in the cloud server 140 enable the authentication schemes as disclosed herein. In some embodiments, the authentication of a product as to its authenticity is carried out by an NFC-enabled device that is capable of communicating both the NFC chip 230 on the product and the cloud server 140 and carrying out the authentication based on such communication. Such an NF-enabled device may be a smart phone or any other types of device with an NFC-enabled authentication application running therein to conduct necessary authentication operations. The NFC-enabled device is used to communicate with the AuthTag 110 when it is in proximity of the AuthTag 110 and such communication leads to activation of the NFC-enabled authentication application on the NFC-enabled device.

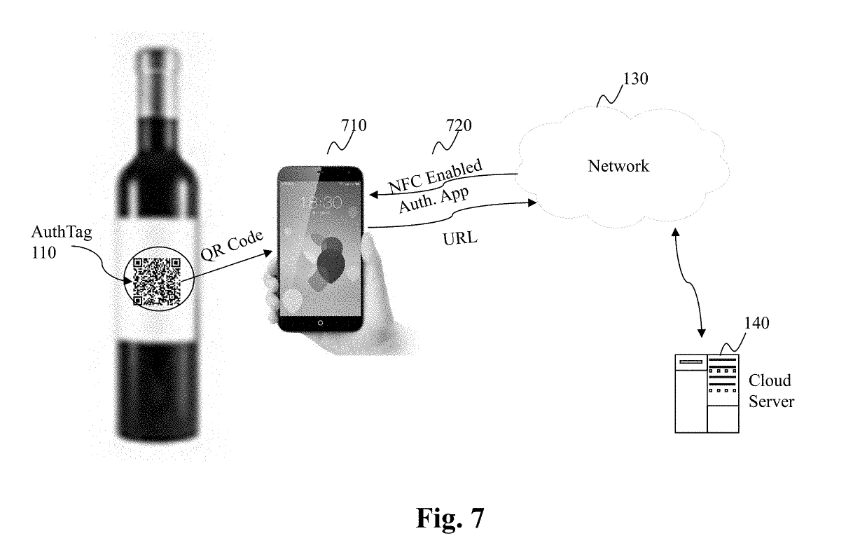

FIG. 7 depicts an exemplary high level system schematic of activating the NFC-enabled authentication application, according to an embodiment of the present teaching. When an NFC-enable device 710 is in proximity of a product with an AuthTag 110 placed thereon, the NFC-enabled device 710 reads the QR code 210 from the AuthTag 110. The NFC-enabled device then processes the QR code 210 to extract information that represents a pointer to the NFC-enabled authentication application. In some embodiments, the pointer is a Universal Resource Locator (URL) that provides an Internet address from where the NFC-enabled authentication application can be retrieved. The NFC-enabled device 710 then sends the pointer (URL) via the network 130 to the cloud server 140 so that the NFC-enabled authentication application 720 can be retrieved and sent to the NFC-enable device 710. In some embodiments, the pointer or URL may also represent a different resource (other than the cloud server 140) from where the NFC-enabled authentication application 720 resides.

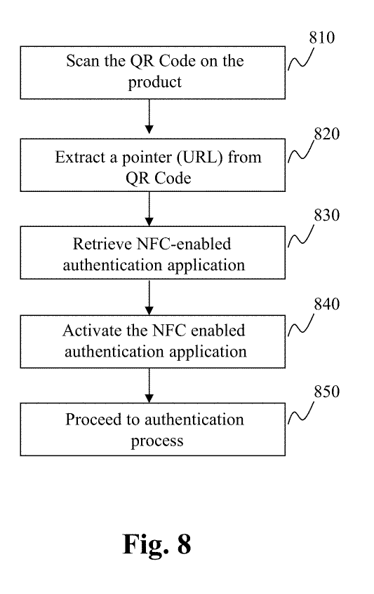

FIG. 8 is a flowchart of an exemplary process of activating an NFC-enabled authentication application 720 on an NFC-enabled device 710, according to an embodiment of the present teaching. At 810, the NFC-enabled device 710 scans the QR code 210 of an AuthTag 110. The QR code 210 is processed to extract, at 820, a pointer (e.g., URL), pointing to the resource where the NFC-enabled authentication application 720 resides. The pointer is then used by the NFC-enable device 710 to retrieve, at 830, the NFC-enabled authentication application. Once retrieved, the NFC-enabled authentication application 720 is activated, at 840, on the NFC-enabled device to proceed, at 850, the authentication process.

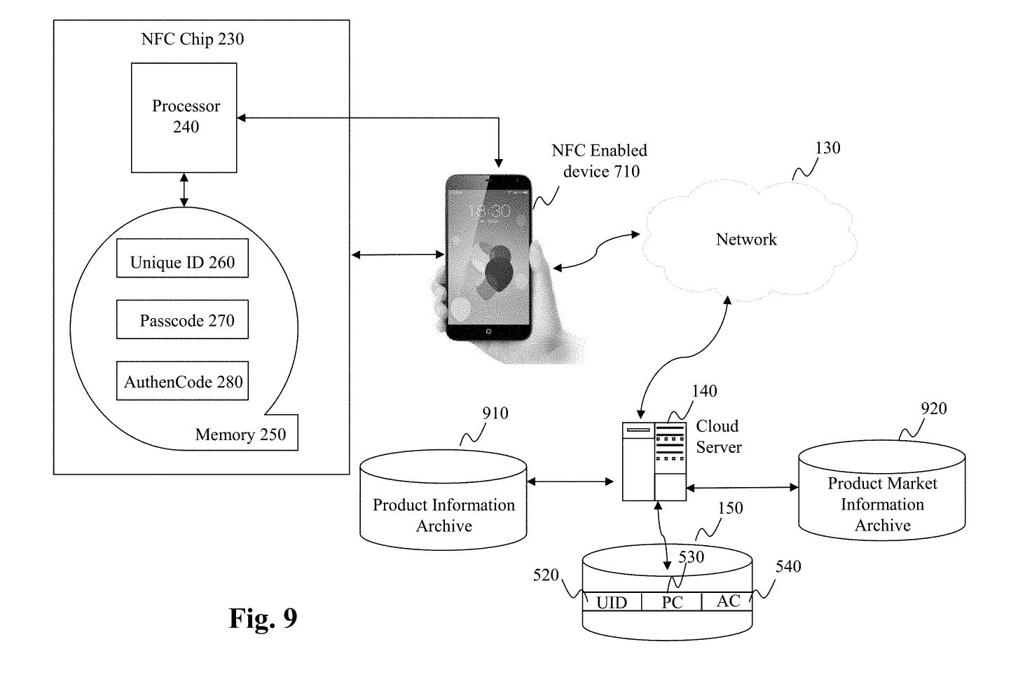

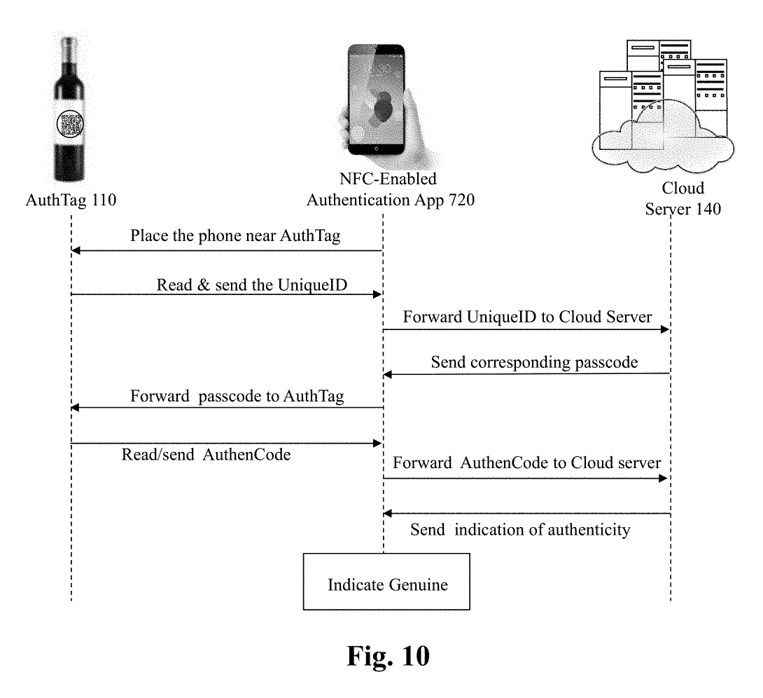

FIG. 9 depicts an exemplary high level system construct of authenticating a product via the NFC-enabled authentication application 720 deployed on an NFC-enabled device 710, according to an embodiment of the present teaching. In FIG. 9, the NFC chip 230 is embedded in an AuthTag 110 that has been attached to a product to be authenticated. As discussed herein, the NFC chip 230 comprises a processor 240 and a memory 250, which stores a 3-tuple {Unique ID 260, Passcode 270, and an AuthenCode 280}. When the NFC-enabled authentication application 720 is deployed and activated on the NFC-enabled device 710, it communicates wirelessly with the NFC chip 230 to initiate the authentication based on an exemplary authentication protocol shown in FIG. 10, which depicts an exemplary protocol scheme of authenticating a product via an NFC enabled application in connection with a cloud server, according to an embodiment of the present teaching. In this exemplary scheme, there comprises three parties involved in the authentication process, including the AuthTag 110 (or specifically the NFC chip 230), the NFC-enabled authentication application 720, and the cloud server 140.

When the NFC-enabled device 710 is nearby the AuthTag 110, the NFC-enabled authentication application 720 triggers the processor 240 to read the Unique ID 260 stored in the memory 250 and send to the NFC-enabled authentication application 720. Upon receiving the Unique ID 260, the NFC-enabled authentication application 720 forwards it, via the network 130, to the cloud server 140. When the cloud server receives the Unique ID 260, based on the received Unique ID 260, it searches in the server database 150 for a 3-tuples that has a UID 520 that matched the received Unique ID 260. When the matching UID is found, the cloud server 140 retrieves the passcode PC 530 stored in the matching 3-tuple and sends the PC 530 to the NFC-enabled authentication application 720.

When the NFC-enabled authentication application receives the PC 530, it forwards it to the AuthTag 110 for authentication. If the PC 530 does not match the passcode 270 stored in the 3-tuple in the NFC chip 230, the AuthTag 110 will not respond. In this case, the authentication fails. In this case, as the cloud server 140 does not receive any further communication on the authentication related to the matching 3-tuple stored in the server database, the cloud server 150 may then log it as a failed authentication associated with a product identified by the UID 520.

If the PC 530 matches with the passcode 270 in the AuthTag 110, the NFC chip in the AuthTag 110 retrieves the AuthenCode 280 stored in the 3-tuple in the memory 250 and sends it to the NFC-enabled authentication application 720, which then forwards it to the cloud server 140. If the AuthenCode 280 does not match the AC 540 in the matching 3-tuple stored in the server database 150, the authentication also fails and the cloud server 140 may log an authentication failure event associated with a product identified by UID 520. If the AuthenCode 280 matches the AC 540 stored in the matching 3-tuple, the cloud server 140 then log a success with the authentication and sends an indication of authenticity of the product to the NFC-enabled authentication application 720.

In some embodiments, the success or failure of the authentication with regard to each product may be logged in a product market information archive 920. Each of such log entry may also be recorded with additional information, e.g., the geographical location of the product, which can be made available by the NFC-enabled device 710 via, e.g., a locator such as GPS of the device. Such gathered information not only reports counterfeit activities with location information but also provides additional market information about distributions of the products that are under the management of the cloud server 140. The counterfeit information may be used to assist manufacturers or distributors to be aware of counterfeit patterns in different regions of the world and/or to prevent future counterfeiting activities. The product distribution information may also enable manufacturers or distributors of products to obtain valuable insight as to the markets.

Referring back to FIG. 9, in some embodiments, when a product is authenticated, the mechanism as disclosed herein may also be used to enhance consumer experience in using a product protected by such an authentication process to ensure authenticity. For example, as discussed earlier, the cloud server 140 may store relevant product information associated with each product. Such product information may be retrieved from a product information archive 910 whenever the authentication is successful and sent to the consumer on the NFC-enabled device to not only present an indication of the authenticity but also provide other content related to the authenticated product to enhance the experience of consuming the product. For example, if a product being authenticated is a bottle of wine, the relevant product information may be the contextual information about the wine, the winery that produces the wine, the history of the winery, or even other surrounding knowledge on, e.g., how to consume the product or how to keep the product, etc.

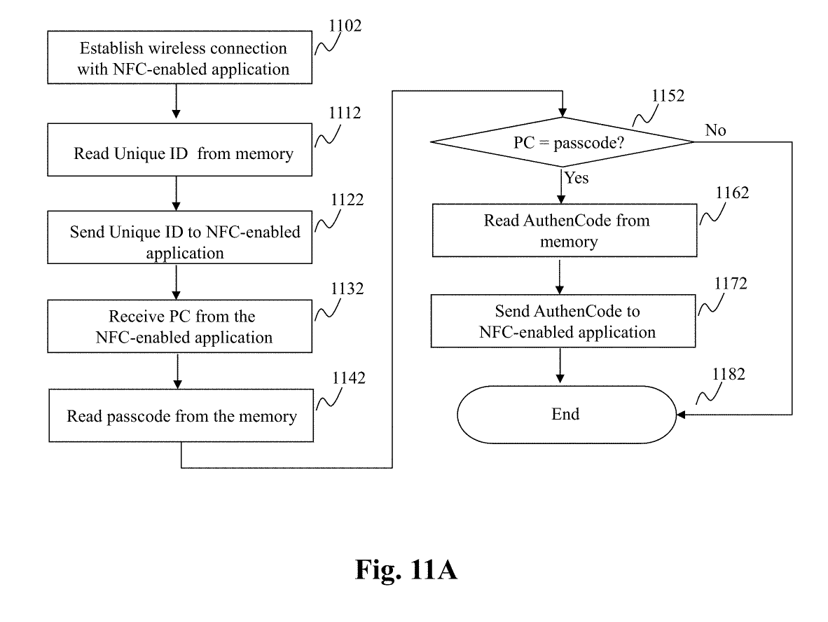

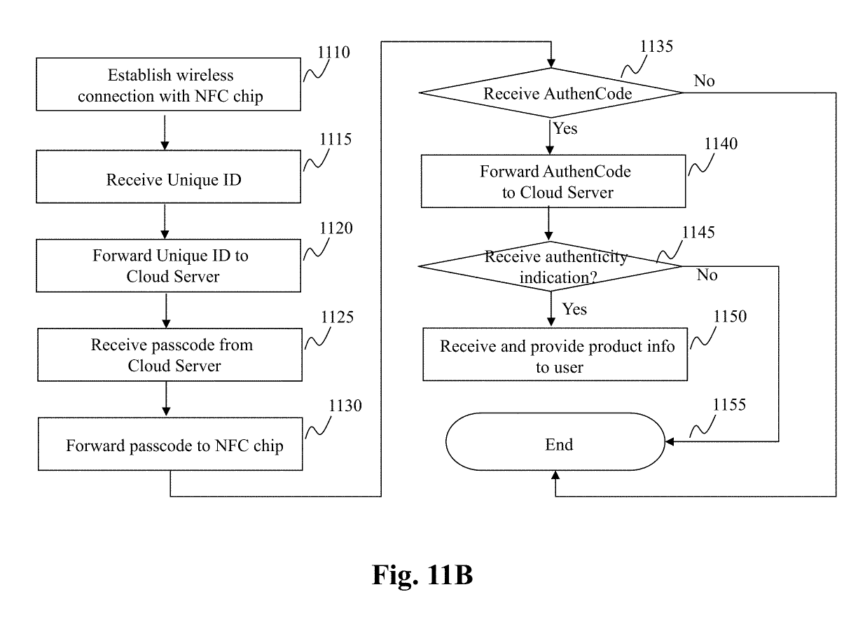

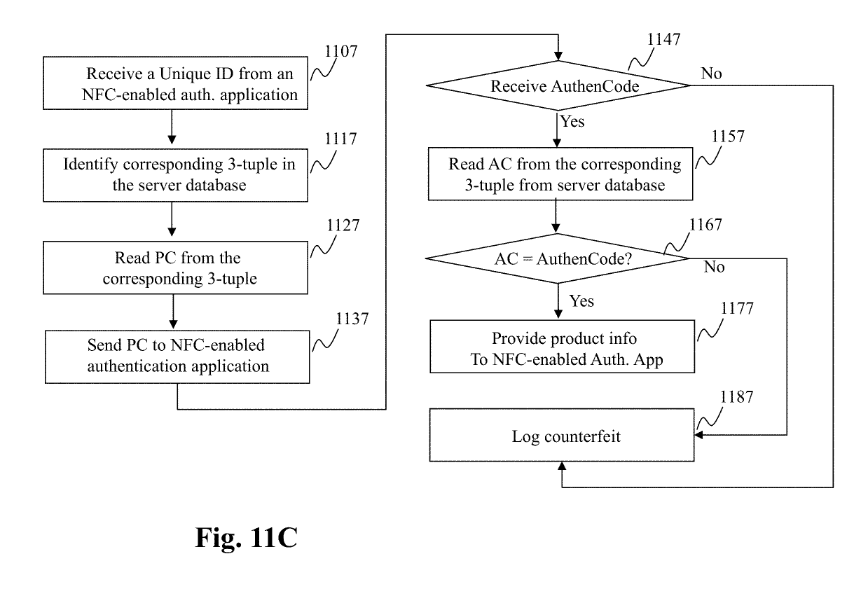

FIG. 11A-11C provide flowcharts of exemplary processes of the NFC chip 230, the NFC-enabled authentication application 720, and the cloud server 140, according to the embodiments of the present teaching. Specifically, FIG. 11A is a flowchart of an exemplary process of the NFC chip 230 to authenticate a product, according to an embodiment of the present teaching. The wireless connection is first established, at 1102, with the NFC-enabled authentication application 720 when it is nearby the NFC chip 230. The processor 240 of the NFC chip proceeds to read, at 1112, the Unique ID 260 and sends, at 1122, to the NFC-enabled authentication application 720 via the wireless connection. Then the NFC chip 230 receives, at 1132, the PC from the NFC-enabled authentication application 720, where the NFC-enabled authentication application receives the PC from the cloud server 140.

The NFC chip 230 then reads, at 1142, the passcode 270 stored in the memory 250 and compares, at 1152, with the received PC. If the read passcode equals to the received PC, the NFC chip 230 reads, at 1162, the stored AuthenCode 280 and sends, at 1172, to the NFC-enabled authentication application 720. If the passcode 270 stored in the NFC chip 230 is not the same as the PC from the cloud server 140, the NFC chip 230 terminates the authentication process at 1182. In this case, as there is no AuthenCode 280 sent from the NFC chip 230 to the NFC-enabled authentication application 720, the cloud server 140 also will not receive the AuthenCode 280 from the NFC chip for verification so that the authentication fails. In this case, the product is considered as a counterfeit.

FIG. 11B is a flowchart of an exemplary process of the NFC-enabled authentication application 720 to authenticate a product, according to an embodiment of the present teaching. As discussed above, the NFC-enabled device 710 may be a smart phone of a consumer who bought a product and likes to authenticate the product. When the NFC-enabled device is in close proximity with the AuthTag 110 on the product, the QR Code on the AuthTag is read and used to deploy the NFC-enabled authentication application 720. Once deployed, the NFC-enabled authentication application 720 establishes, at 1110, a wireless connection with the NFC chip of the AuthTag 110.

When the NFC-enabled authentication application 720 receives, at 1115, the Unique ID 260 from the NFC chip 230, it forwards, at 1120, the received Unique ID 260 to the cloud server 140 via the network 130. When it receives, at 1125, PC 530 from the cloud server, the NFC-enabled application forwards, at 1130, the PC 530 to the NFC chip 230. If AuthenCode 280 is not received from the NFC chip 230 of the AuthTag 110, determined at 1135, the authentication process at NFC-enabled authentication application 720 ends at 1155. If AuthenCode 280 is received from the NFC chip 230, the AuthenCode is forwarded, at 1140, to the cloud server 140 for further verification. If the AuthenCode is verified, the NFC-enabled application 720 receives an indication of authenticity, determined at 1145, from the cloud server 140. When the response indicated authenticity, the NFC-enabled application 720 may also receive together with the indication the information about the product, which is provided, at 1150, to the consumer. If no authenticity indication is received from the cloud server 140, determined at 1145, the authentication process abnormally ends at 1155.

FIG. 11C is a flowchart of an exemplary process of the cloud server 140 to authenticate a product, according to an embodiment of the present teaching. The cloud server 140 receives, at 1107, a Unique ID 260 from an NFC-enabled authentication application 720. Based on the received Unique ID 260, the cloud server 140 identifies, at 1117, a corresponding 3-tuple in the server database 150 with an UID 520 equals to the received Unique ID. Upon identifying the corresponding 3-tuple in the server database 150, the cloud server 140 reads, at 1127, the PC 530 stored in the corresponding 3-tuple and sends, at 1137, the PC to the NFC-enabled authentication application 720. In some situation, it is possible that the cloud server 140 is not able to identify the corresponding 3-tuple. In this case, the authentication may be considered as a failure (not shown).

After sending the PC to the NFC-enabled authentication application 720, the cloud server 140 determines, at 1147, whether the NFC-enabled authentication application 720 sends an AuthenCode to it. If no AuthenCode is received (e.g., within a pre-determined time period), the cloud server 140 proceeds to log, at 1187, an authentication failure event. If the cloud server 140 receives the AuthenCode 280 from the NFC-enabled authentication application, it proceeds to read, at 1157, the AC 540 stored in the corresponding 3-tuple and then determines, at 1167, whether the received AuthenCode 280 equals to the AC 540 read from the server database 250. If AC 540 does not equal to the received AuthenCode 280, the cloud server 140 proceeds to log, at 1187, an authentication failure, i.e., the product is a counterfeit. Otherwise, the cloud server 140 retrieves information related to the product (e.g., based on its Unique ID) and sends, at 1177, such product information to the NFC-enabled authentication application 720.

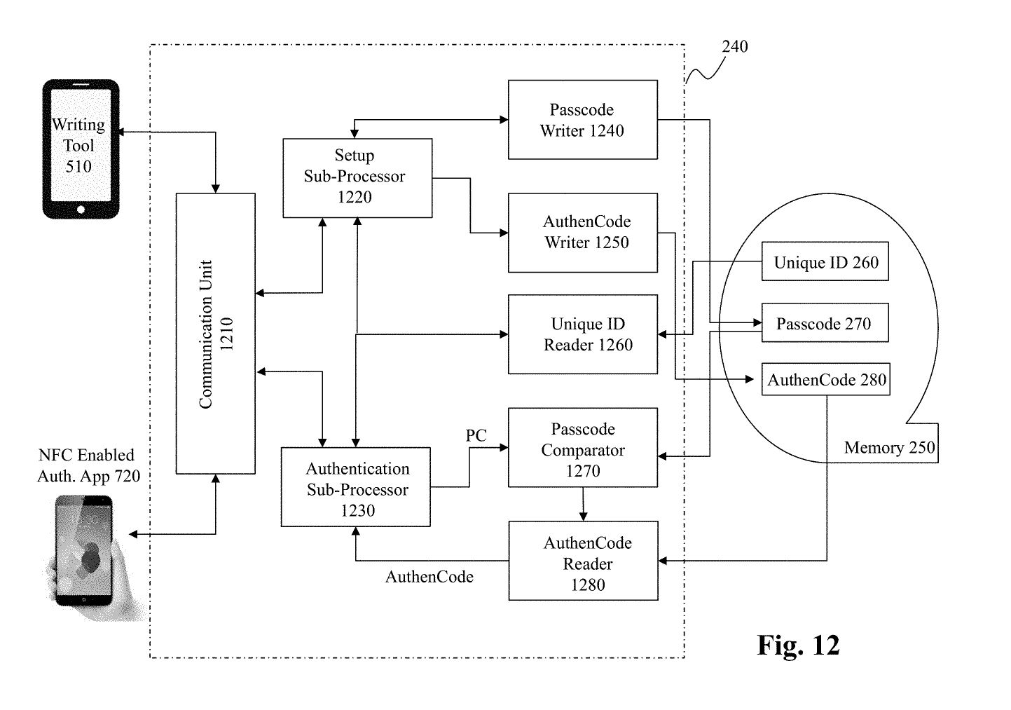

FIG. 12 depicts an exemplary high level system diagram of the processor 240 residing in the authentication tag 230, according to an embodiment of the present teaching. As discussed herein, the processor 240 communicates with both the writing tool 510 for writing the authentication information into the memory 250 and the NFC-enabled authentication application 720 for performing authentication operations. In this exemplary embodiment, the processor 240 comprises a communication unit 1210, a setup sub-processor 1220, and an authentication sub-processor 1230. In the illustrated embodiment, the setup sub-processor 1220 is responsible for facilitating the process of writing authentication information into the memory 250 and the authentication sub-processor 1230 is responsible to performing operational steps related to the authentication. To interface with the memory 250, the processor 240 further comprises a passcode writer 1240 for writing the passcode 270 into the memory 250, an AuthenCode writer 1250 for writing an AuthenCode 280 into the memory 250, a unique ID reader 1260 for reading the Unique ID 260 from the memory 250, a passcode comparator 1270 for comparing a received PC (from the cloud server 140) with the stored passcode 270, and an AuthenCode reader 1280 for reading the stored AuthenCode 280.

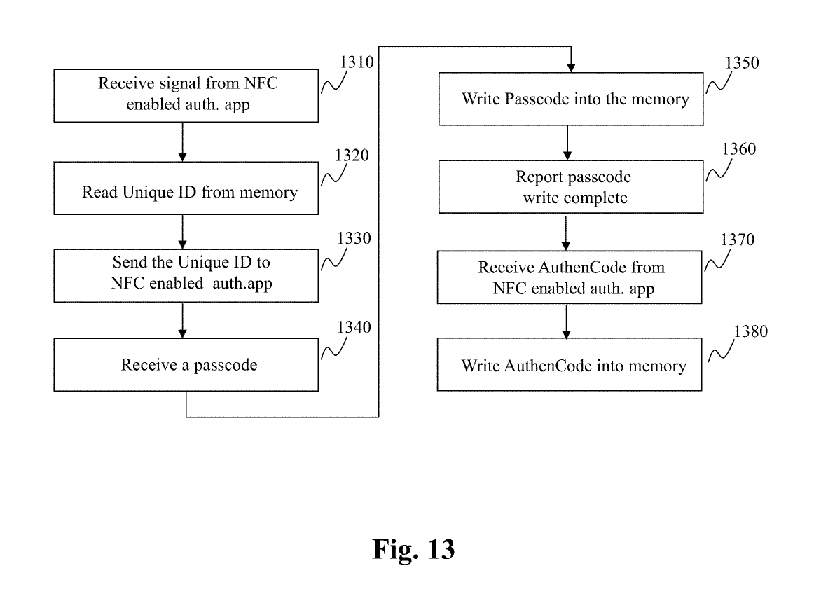

In operation, during the writing process, to communicate with the writing tool 510, the communication unit 1210 interfaces with the writing tool 510 to populate the memory 250. FIG. 13 is a flowchart of an exemplary process of the writing process, according to an embodiment of the present teaching. When the writing tool 510 is nearby the NFC-chip 230, the communication unit 1210 may receive, at 1310, a signal indicating the presence of the writing tool 510. To initiate the writing process, the communication unit 1210 invokes the setup sub-processor 1220 to start by reading, at 1320, the Unique ID 260 stored in the memory 250 of the NFC chip 230. To do so, the setup sub-processor 1220 may trigger the unique ID reader 1260 to read the Unique ID 260 from the memory 250 and sends the retrieved Unique ID 260 to the communication unit 1210. Upon receiving the Unique ID 260, the communication unit 1210 sends it, at 1330, to the writing tool 510.

As discussed previously, based on each unique ID stored in an NFC chip, passcode and AuthenCode are accordingly generated to form a 3-tuple. When the writing tool 510 receives the Unique ID read from the memory, it proceeds to obtain, either from the cloud server 140 or generated by itself, a passcode generated based on the received Unique ID. The writing tool 510 then sends the passcode via the communication unit 1210 to the setup sub-processor 1220. Upon receiving, at 1340, the passcode 270, the setup sub-processor 1220 activates the passcode writer 1240 with the received passcode so that the passcode writer 1240 can write, at 1350, the passcode into the memory 250. Upon successfully writing the passcode into memory 250, the passcode writer 1240 may inform the setup sub-processor 1220, which in turn reports, at 1360, to the writing tool 510 via the communication unit 1210. The writing tool 510 then obtains, either by generating or receiving from the cloud server 140, an AuthenCode generated based on the passcode written into the memory 250 and sends to the setup sub-processor 1220 via communication unit 1210. Similarly, upon receiving the AuthenCode, at 1370, at 1380, the setup sub-processor 1220 invokes the AuthenCode writer 1250 to write it to the memory 250 to complete the 3-tuple in the NFC chip 230. In some embodiments, the successful writing of the AuthenCode may also be conveyed to the writing tool 510 so that a corresponding 3-tuple may be accordingly stored in the server database 150 of the cloud server 140 for future authentication.

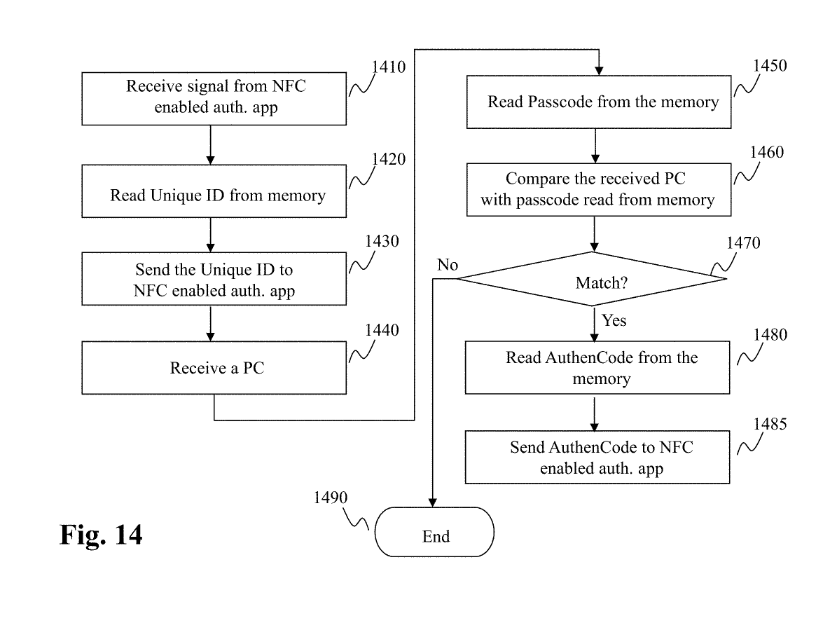

During the authentication process, the processor 240 interacts with the NFC-enabled authentication application 720 to perform authentication. FIG. 14 is a flowchart of an exemplary process for authentication, according to an embodiment of the present teaching. When the NFC chip 230 is in a close proximity with the NFC-enabled device 710 (where the NFC-enabled authentication application 720 is deployed), the communication unit 1210 receives, at 1410, a signal indicating the presence of the NFC-enabled authentication application 720 and then activates the authentication sub-processor 1230 to initiate the authentication process. The authentication sub-processor 1230 activates the unique ID reader 1260 to read, at 1420, the Unique ID 260 from the memory 250. The Unique ID 260 is then sent, at 1430, to the NFC-enabled authentication application 720 via the authentication sub-processor 1230 and the communication unit 1210. When the authentication sub-processor 1230 receives, at 1440, a PC from the NFC-enabled authentication application 720, it activates the passcode comparator 1270 to read, at 1450, the passcode 270 stored in the memory 250 and compare, at 1460, the received PC with the retrieved passcode 270. If they match, determined by the passcode comparator at 1470, the authentication sub-processor 1270 activates the AuthenCode reader 1280 to read, at 1480, the AuthenCode 280 from the memory and then sends, at 1485, the retrieved AuthenCode 280 to the NFC-enabled authentication application 720. If the received PC does not match the retrieved passcode 270, the authentication sub-processor 1230 terminates, at 1490, the process and may optionally report (not shown) the same to the NFC-enabled authentication application 720.

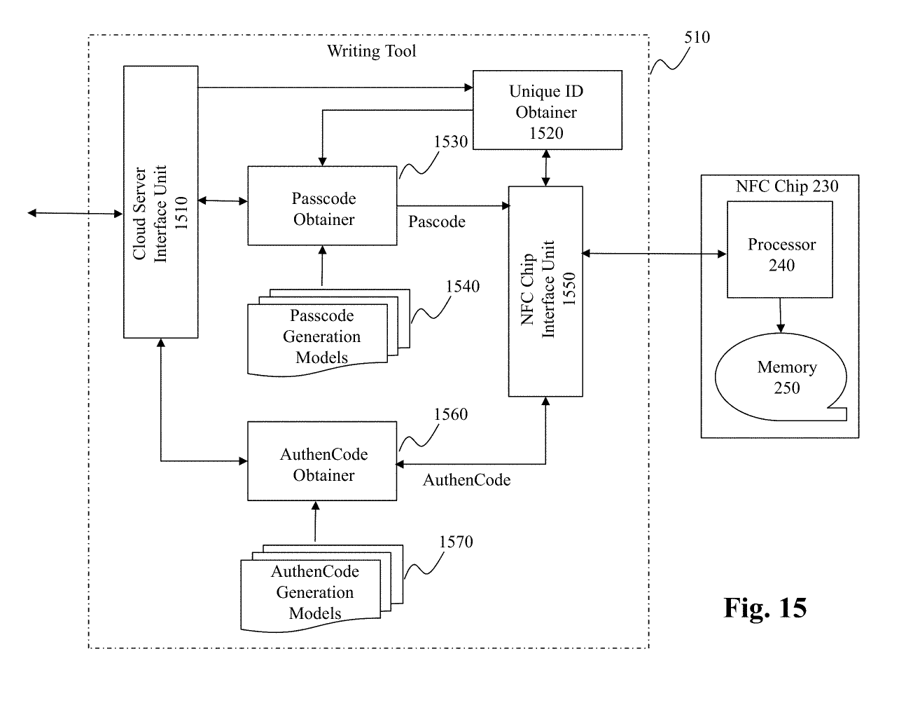

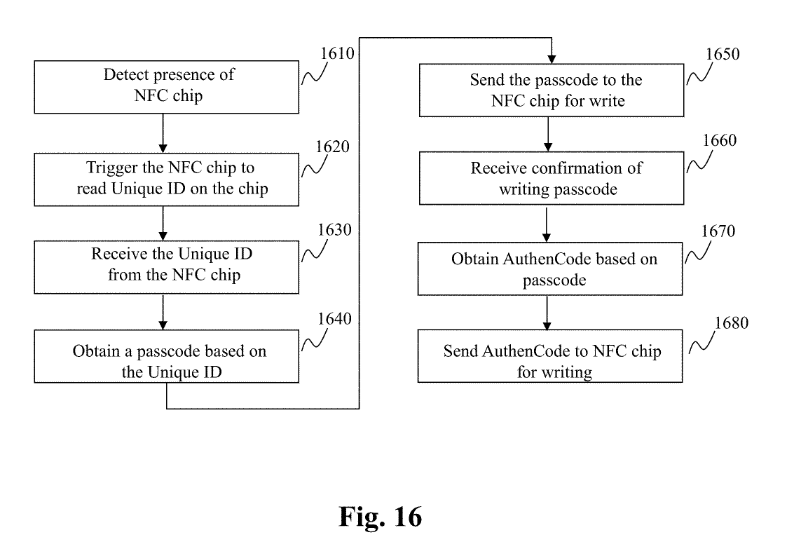

FIG. 15 depicts an exemplary high level system diagram of the writing tool 510, according to an embodiment of the present teaching. In the illustrated embodiment, the writing tool 510 comprises a cloud server interface unit 1510 and an NFC chip interface unit 1550 for interfacing the outside world, a unique ID obtainer 1520, a passcode obtainer 1530, and an AuthenCode obtainer 1560. FIG. 16 is a flowchart of an exemplary process of the writing tool 510, according to an embodiment of the present teaching. In operation, when the writing tool 510 detects, at 1610 in FIG. 16, the presence of the NFC chip 230, NFC chip interface unit 1550 triggers, at 1620, the NFC chip to read the Unique ID stored on the chip. When the unique ID obtainer 1520 receives, at 1630, the Unique ID 260 via the NFC chip interface unit 1550, it obtains, at 1640, a passcode determined based on the Unique ID. As discussed herein, the passcode may be generated by the writing tool 510 or by the cloud server 140, If it is generated by the writing tool 510, the passcode obtainer 1530 generates the passcode 270 based on the Unique ID 260 in accordance with any of passcode generation models stored in 1540. One exemplary model may be based on SHA algorithm. The passcode 270, once generated, may then be sent by the passcode obtainer 1530 to the cloud server 140 via the cloud server interface unit 1510 so that it can be stored in the cloud server as PC 530.

If the passcode is to be generated by the cloud server 140, the passcode obtainer 1530 sends the Unique ID 260 to the cloud server 140 via the cloud server interface unit 1510 and subsequently receives, the passcode 270 generated by the cloud server 140 via the cloud server interface 1510. Once the passcode 270 is obtained, either locally generated or from the cloud server 140, the passcode obtainer 1530 sends, at 1650, the passcode 270 to the NFC chip 230 via the NFC chip interface unit 1550 for writing into the NFC chip 230. If the writing is successful, the NFC chip interface unit 1550 receives, at 1660, a signal indicating as such and obtains, at 1670, AuthenCode 280 for writing. Similar to the passcode 270, the AuthenCode 280 may be either received from the cloud server 140 or generated by the AuthenCode obtainer 1560 based on the passcode 270 in accordance with any of AuthenCode generation models stored in 1570. Once the AuthenCode 280 is obtained, it is sent, at 1680, to the NFC chip 230 via the NFC chip interface unit 1550 for writing into the memory 250. If the AuthenCode 280 is generated locally by the writing tool, the AuthenCode obtainer 1560 may also send the AuthenCode 280 to the cloud server 140 to be stored as AC 540 so that the 3-tuple {UID, PC, and AC} is complete.

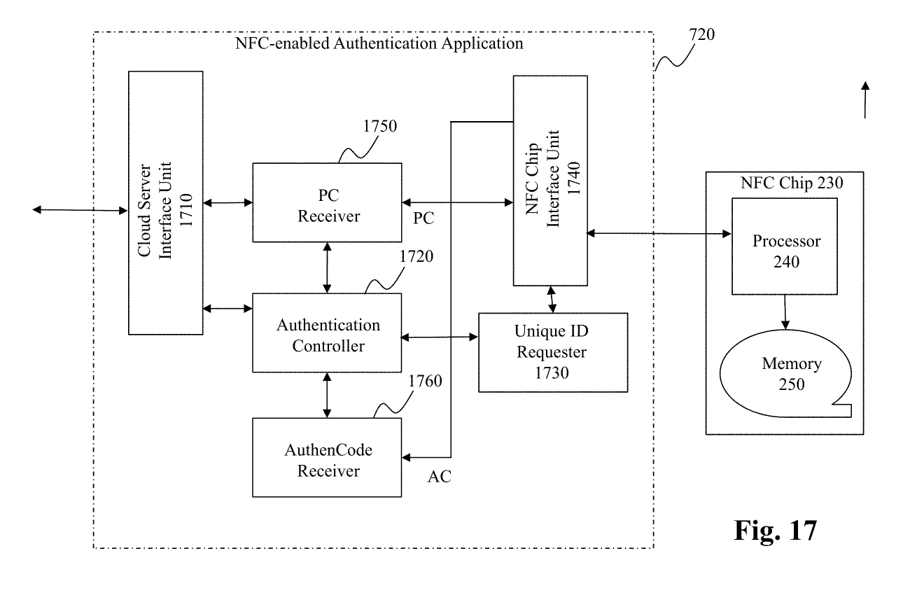

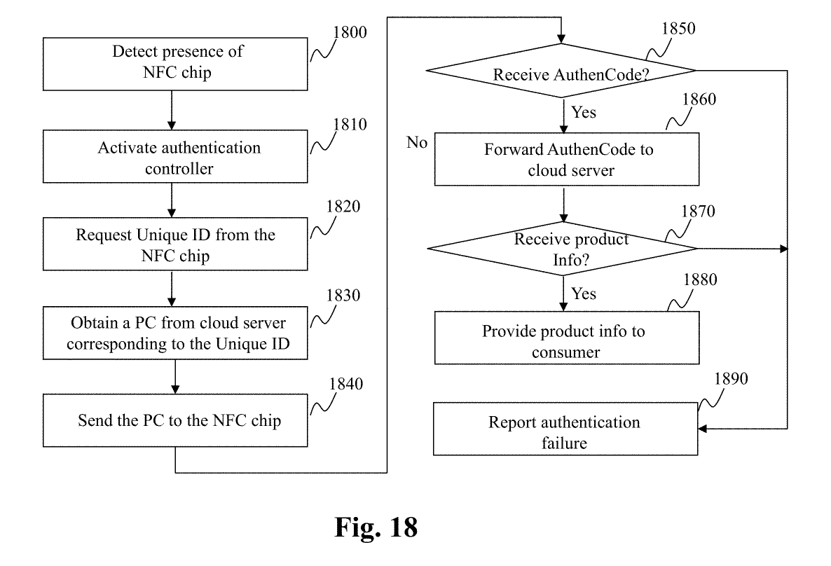

FIG. 17 depicts an exemplary high level system diagram of the NFC-enabled authentication application 720, according to an embodiment of the present teaching. In the illustrated embodiment, the NFC-enabled authentication application 720 comprises a cloud server interface unit 1710 and an NFC chip interface unit 1740 for interfacing the outside world, a unique ID obtainer 1520, an authentication controller 1720, a unique ID requester 1730, a PC receiver 1750, and an AuthenCode receiver 1760. FIG. 18 is a flowchart of an exemplary process of the NFC-enabled authentication application 720, according to an embodiment of the present teaching. In operation, when the NFC-enabled authentication application 720 detects, at 1800, the presence of an NFC chip 230, it activates, at 1810, the authentication controller 1720. Once activated, the authentication controller 1720 initiates the authentication process by triggering the unique ID requester 1730 to request, at 1820, the Unique ID 260 from the NFC chip 230. When the authentication controller 1720 receives the Unique ID 260 via the unique ID requester 1730 and the NFC chip interface unit 1740, it triggers the PC receiver 1750 to communicate with the cloud server 140 via the cloud server interface unit 1710 to obtain, at 1830, PC 530. The PC receiver 1750 then sends, at 1840, the PC 530 to the NFC chip 230 via the NFC chip interface unit 1740.

The authentication controller 1720 may also trigger the AuthenCode receiver 1760 to wait to see if the AuthenCode 280 is sent from the NFC chip via the NFC chip interface unit 1740. If the AuthenCode 280 is received, determined at 1850, the AuthenCode receiver 1760 sends the AuthenCode 280 to the authentication controller 1720 which then forwards, at 1860, to the cloud server 140 via the cloud server interface unit 1710. If the NFC-enabled authentication application 720 does not receive the AuthenCode 280, which may indicate that the PC 530 received does not match the passcode 270 stored in NFC chip, the authentication controller 1720 reports, at 1890, authentication failure to the cloud server 140 via the interface unit 1710.

Once the AuthenCode 280 is sent to the cloud server 140, the NFC-enabled authentication application 720 waits to see if the cloud server 140 sends product information. As discussed herein, if the AuthenCode 280 is verified to be equal to AC 540, then authentication is successful and the cloud server 140 in this case may send information related to the authenticated product to the NFC-enabled authentication application 720 so that it may provide such information to the consumer to enhance the consumer experience. So, if the product information is received, determined at 1870, the authentication controller 1720 may provide, at 1880, the product information to a consumer or a user of the NFC-enabled device 710. If the NFC-enabled authentication application 720 does not receive the product information, e.g., within a period of time or being explicitly informed by the cloud server 140 via the interface 1710, the authentication process proceeds to 1890 to report a failure.

FIG. 19 depicts an exemplary high level system diagram of the cloud server 140, according to an embodiment of the present teaching. In this illustrated embodiment, the cloud server 140 comprises a communication platform 1905 for interfacing with the outside world, a first portion for collaborating with the writing tool 510 to ensure consistent writing of two 3-tuples into the cloud server 140 and each NFC chip 230, a second portion for collaborating with an NFC-enabled authentication application to perform authentication, and a third portion for providing market information related to products to facilitate market analysis. The first portion includes an initialization instruction generator 1915, a 3-tuple initializer 1910, a code obtainer 1920, and a code archiver 1930. The second portion for authentication includes a PC retriever 1940, an AC verifier 1950, a product information retriever 1965, and an authentication result processing unit 1960. The third portion for generating market related information includes an authenticity information classifier 1970, a third party market information processing unit 1980, and a product market analyzer 1990.

Each portion handles different tasks and populates/interfaces with different types of information and different databases. The first portion populates the server database 150 for storing authentication information as 3-tuples. The second portion retrieves information from the server database 150 for authentication and obtains relevant product information from the product information archive 910 in the event of successful authentication. The third portion analyzes information from different parties and store into the product market information archive 920. The information stored in the product market information populated by the third portion may be retrieved and used to assist to understand the product market and accordingly make decisions as to how to develop the market further (now shown).

During the process of setting up the 3-tuples, the initialization instruction generator 1915 may receive an command from outside providing, e.g., a list of UIDs to initialize the 3-tuples. For example, when a batch of NFC chips are produced, the manufacturer of the NFC chips may provide the Unique IDs built in the chips so that the cloud server 140 may set up in the server database 150 accordingly. Alternatively, the cloud server 140 may generate Unique IDs to be embedded in the NFC chips and then accordingly archive them in the server database 150 as well (not shown). The initialization instruction generator 1915 may send the instruction for populating a plurality of 3-tuples to the 3-tuple initializer 1910, which in turn may write 3-tuple records into the server database 150, each with UID 520 being corresponding to the Unique ID received. Once the 3-tuples in the server database 150 are initialized, the cloud server 140 can proceed to the writing process.

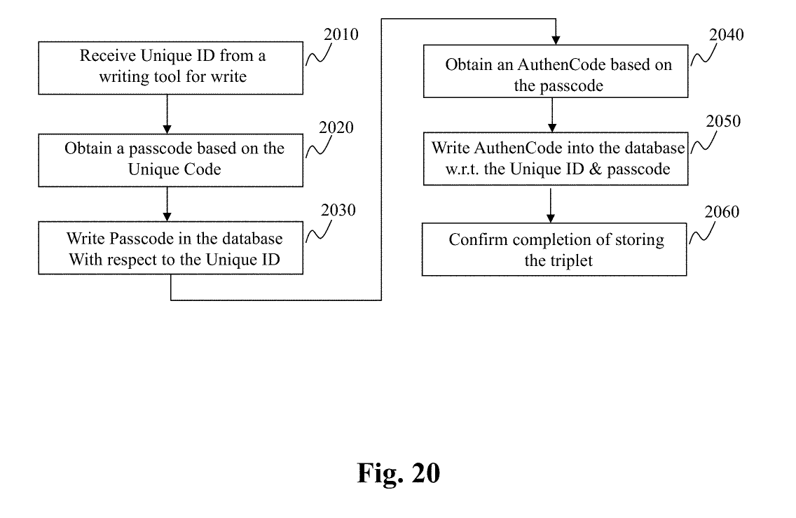

FIG. 20 is a flowchart of an exemplary process of the first portion of the cloud server 140 to populate authentication information, according to an embodiment of the present teaching. When the cloud server 140 receives, at 2010, a Unique ID from a writing tool, it obtains, at 2020, a passcode based on the Unique ID. As discussed herein, the passcode may be generated by the writing tool and then received by the code obtainer 1920 via the communication platform 1905 of the cloud server 140. Alternatively, the passcode may also be generated by the code obtainer 1920 based on the Unique ID. The passcode is what is saved in an NFC chip and when it is received by the cloud server 140, it is then written, by the code archiver 1930 at 2030, into the server database as PC 530. An AuthenCode is then obtained, by the code obtainer 1920 at 2040, either from the writing tool or generated by the code obtainer 1920. The AuthenCode is generated based on the passcode or PC. Such obtained AuthenCode is then written, by the code archiver 1930 at 2050, into the server database 150 as AC 540. This completes the population of a 3-tuple.

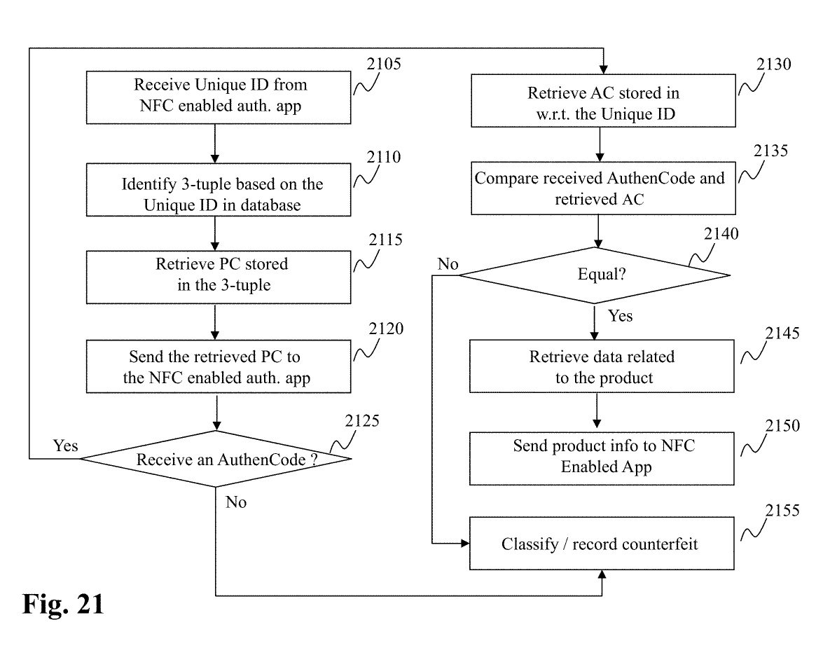

FIG. 21 is a flowchart of an exemplary process of the second portion of the cloud server 140 to authenticate a product, according to an embodiment of the present teaching. During authentication, when the communication platform 1905 in the cloud server 140 receives, at 2105, Unique ID 260 from an NFC enabled authentication application 720, the PC retriever 1940 is triggered to identify, at 2110, a 3-tuple that has its UID equals to the received Unique ID retrieve, at 2115, the PC stored in the 3-tuple, and send, at 2120, the retrieved PC to the NFC-enabled authentication application 720 via the communication platform 1905. If the cloud server 140 subsequently does not receive an AuthenCode, determined at 2125, the cloud server 140 proceeds to classify, at 2155, the authentication as a failure or the product that has Unique ID is a counterfeit.

If the communication platform 1905 receives an AuthenCode 280, determined at 2125, the AC verifier 1950 proceeds to retrieve, at 2130, the stored AC from the 3-tuple, that has its UID equal to the Unique ID, and compare, at 2135, the received AuthenCode 280 and the retrieved AC 540. If they are not equal, determined at 2140, the cloud server 140 considers the authentication failed and classifies, at 2155, the product with Unique ID as a counterfeit. If the AuthenCode 280 equals the AC 540, the product information retriever 1990 retrieves, at 2145, information related to the product that has just been authenticated and sends, at 2150, such product information to the NFC-enabled authentication application 720 via the communication platform 1905.

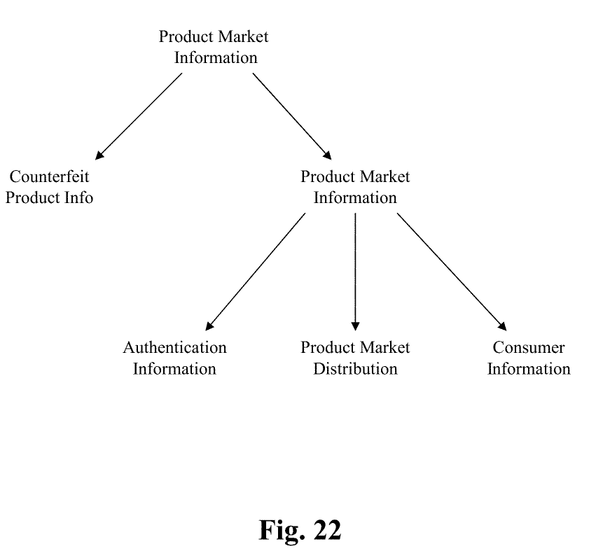

The process of the third portion of the cloud server 140 related to collecting market information related to different products that can be authenticated in accordance with the approaches as disclosed herein. FIG. 22 illustrates exemplary types of information that may be collected via the authentication process disclosed, according to an embodiment of the present teaching. Product market information that may be collected during the authentication and via third party information sources may include counterfeit product information as what was disclosed herein. In some embodiments, the counterfeit product information may include the information about the product itself as well as any peripheral information that surrounds the authentication. Information about the product itself may include presumed Unique ID as well as the presumed product name under that Unique ID, maker, distributor, and/or date of the production. Peripheral information that surrounds the product may include location where the product was authenticated but failed (the NFC-enabled authentication application 720 may obtain that information from the NFC-enabled device 710).

The information that can be collected by the cloud server 140 may also include any product market data associated with the products that have been released to the market. Examples include their authentication information, product distribution information, as well as consumer information. For example, authentication information may be from recorded authentication logs from various servers of the cloud server 140 distributed in different parts of the world, from which it is possible to identify areas of counterfeiting activities and concentration/density thereof, areas of high rate of authentication successes, etc. The information about the product market distribution may also be obtained based on the authentication logs. For example, the presence of a product in different regions of the world may be derived based on authentication logs and the popularity and growth potentials of the product may also be estimated based on the statistics from the logs.

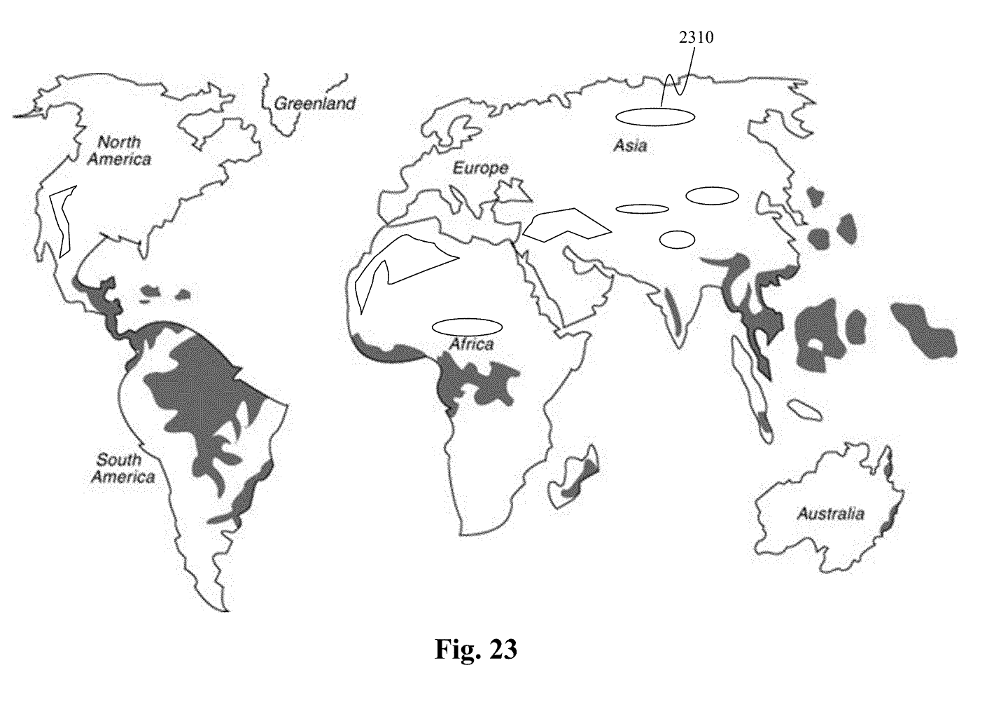

FIG. 23 illustrates an example of such a map with different regions identified representing presence of a product, according to an embodiment of the present teaching. In this figure, there are different patches marked in different colors, each color may represent a certain classification. For example, green regions may represent the presence of the product with above 90 percent of authentication success, black regions 2310 may represent regions that have an authentication failure rate above 30%, blue regions may represent regions where the product authentication success/failure rates are mixed yet still failure below 15%, purple region may represent regions where the product authentication success/failure rates are mixed and has exceeded 15%, while a red region may means that the product authentication success/failure rates are mixed but the failure rate is almost at 30%. As can be seen, data collected via the authentication process as described herein can facilitate the cloud server 140 to collect useful information and turn such collected information into business information that can be exploited beyond the authentication itself.

As depicted in FIG. 19, the cloud server 140 is configured to collect additional information from any 3^{rd} party data provider 1900. Such information may be related to additional aspects of the product market information. Examples may include consumer information from sources such as social media platforms (consumers or interest groups chat about products), magazines (product review articles), trade publications, etc. Such consumer information may also be correlated with the product market distribution information as discussed above so that conclusions/inferences may be derived to assist manufacturers/distributors of products in order to adjust market strategy or product design.

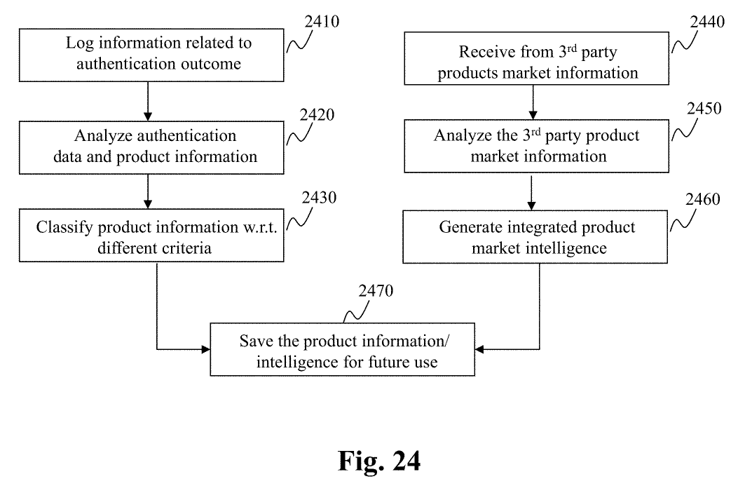

FIG. 24 is a flowchart of an exemplary process for the third portion of the cloud server 140, according to an embodiment of the present teaching. As discussed previously with reference to FIG. 19, the third portion comprises the authentication result processing unit 1960, the authenticity information classifier 1970, the third party market information processing unit 1980, and a product market analyzer 1990. In operation, in the event of either an authentication success or a failure, the authentication result processing unit 1960 is informed by, e.g., the AC verifier 1950. When the AC verifier 1950 either does not receive an AuthenCode from the NFC chip or the AC code is not verified, it informs the authentication result processing unit 1960 an authentication failure. If the authentication is successful, i.e., the AC verifier 1950 verified that the received AuthenCode 280 matches the stored AC 540, the AC verifier 1950 informs the authentication result processing unit 1960 the success.

When the authentication result processing unit 1960 is informed of a success or a failure of authentication from the AC verifier 1950, it logs, at 2410 in FIG. 24, the outcome of the authentication in authentication logs 1975. Based on the recorded logs, the authenticity information classifier 1970 analyzes, at 2420, the information stored in the logs 1975 and may proceed to classify, at 2430, such logged information and such information may be classified in different ways based on different criteria. For example, information may be classified based on product, region, level of authentication success/failure, etc. The classified information is then saved, at 2470, in the product market information archive 920.

At the same, the third party market information processing unit 1980 of the cloud server 140 may also gather or receive, at 2440, product market information from 3^{rd} party data providers 1900. Such collected information from third party providers may then be analyzed, at 2450 by the product market analyzer 1990. The product market analyzer 1990 may also retrieve the previously analyzed product information, e.g., classifications by the authenticity information classifier 1970, and analyze further in combination with the collected third party product market information received from the third party providers 1900. For example, for each class corresponding to a geographical region where the product was sold to, the product market analyzer 1990 may combine 3^{rd} party data corresponding to the evaluation from consumers from that geographical region to further infer the popularity of the product in that region. At 2460, data from different sources related to the products are combined to generate integrated product market intelligence, which is then saved at 2470 in the product market information archive 920 for future use.

The authentication schemes disclosed herein are useful for anti-counterfeit. Through the disclosed different embodiments of performing authentication, any manipulation of an AuthTag 110 associated with a product leads to a failure in authentication because the corresponding 3-tuple stored in the server database 150 is not altered. Another type of possible counterfeit is to replace the content of the authenticate product using counterfeit content without manipulating the AuthTag 110. One example is related to wine product. A counterfeiter may use the bottle of an authenticate wine brand and fill with fake product. To against this types of counterfeit activities, the disclosed authentication schemes may incorporate additional control designed for different types of products. For example, for certain products such as wine, meat, or whatever, the cloud server 140 may enforce one-time authentication strategy. That is, once the authentication is done, the cloud server 140 may prevent any further authentication.

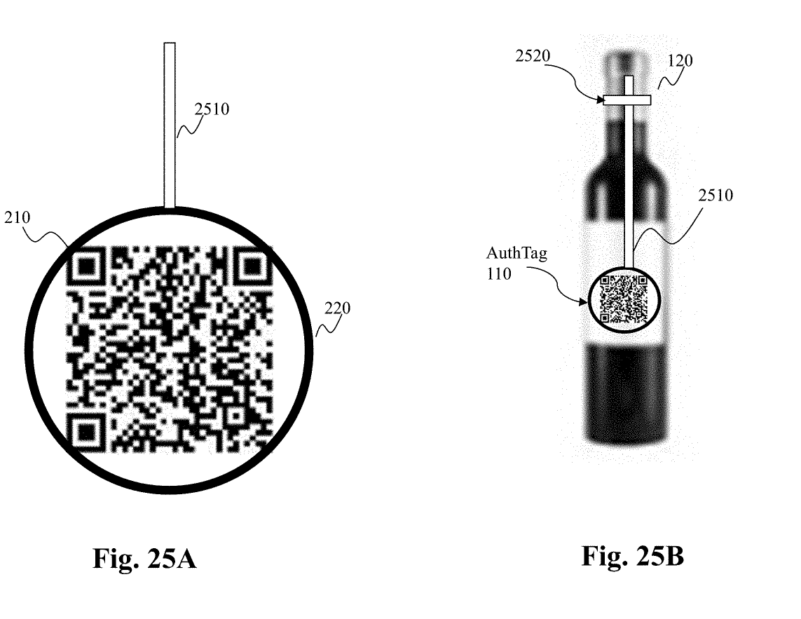

Another alternative or parallel solution is to use anti-tempering mechanism to prevent the AuthTag 110 from being abused for counterfeit purposes. FIG. 25A and FIG. 25B depict an exemplary embodiment of an anti-tempering mechanism for an example product, according to an embodiment of the present teaching. In this illustrated embodiment, the product is a wine bottle. In FIG. 25A, the antenna 220 of an AuthTag 110 is constructed with an extension portion 2510. In FIG. 25B, it shows that the AuthTag 110 with an extended portion of the antenna 2510 is affixed to the wine bottle 120 so that the extension portion 2510 is extended to a portion 2520 of the bottle 120 where the bottle is to be opened. The extension portion 2510 may be affixed during the bottling process underneath the 2520 portion so that when someone opens the bottle, the extension portion 2510 of the antenna is broken so that the NFC chip 230 can no longer communicate with the outside world via the antenna 210 to make it impossible to perform any authentication. In some embodiments, the NFC chip 230 in the AuthTag 110 may be designed to detect any tempering activity and activate the NFC chip to send a signal with the Unique ID via the antenna 210 to the cloud server 140, indicating that for this specific product, there will be no authentication to be performed. In this case, either the product is counterfeit or the consumer decided not to authenticate and proceeded to open the bottle directly. In either case, although the cloud server 140 may not have a way to know the true reason for the break of the AuthTag 110, it does prevent counterfeit.

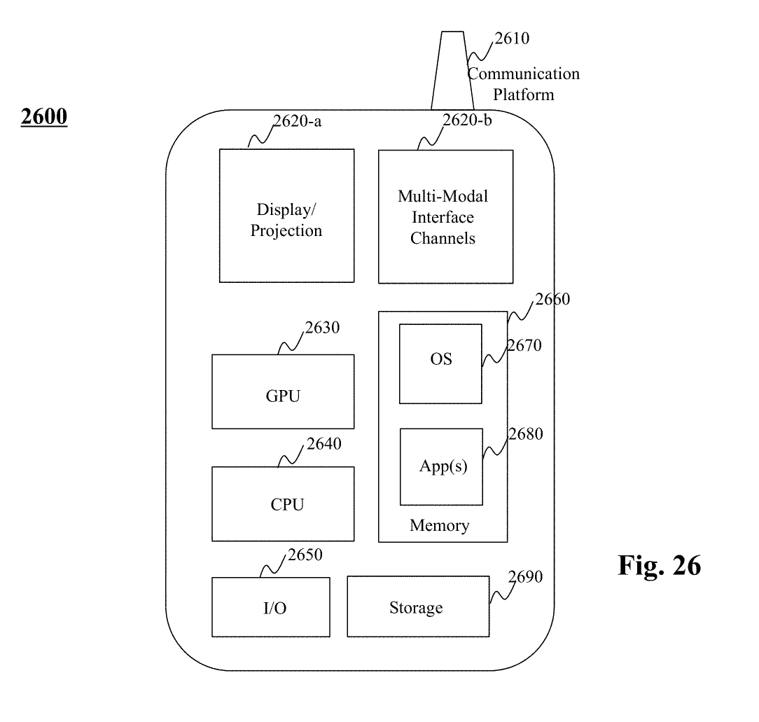

FIG. 26 depicts the architecture of a mobile device which can be used to realize a specialized system implementing the present teaching. This mobile device 2600 includes, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 2600 in this example includes one or more central processing units (CPUs) 2640, one or more graphic processing units (GPUs) 2630, a memory 2660, a communication platform 2610, such as a wireless communication module, storage 2690, one or more input/output (I/O) devices 2650, a display or a projection 2620-a for visual based presentation, and one or more multi-modal interface channels 2620-b. The multi-modal channels may include acoustic channel or other media channels for signaling or communication. Any other suitable component, including but not limited to a system bus or a controller (not shown), may also be included in the mobile device 2600. As shown in FIG. 26, a mobile operating system 2670, e.g., iOS, Android, Windows Phone, etc., and one or more applications 2680 may be loaded into the memory 2660 from the storage 2690 in order to be executed by the CPU 2640.

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to the present teachings as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

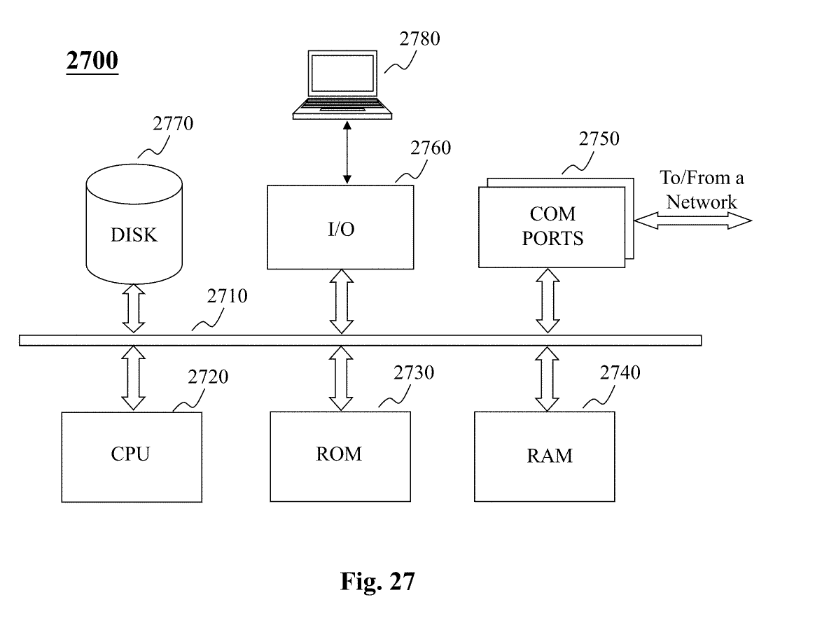

FIG. 27 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 2700 may be used to implement any component of the present teachings, as described herein. Although only one such computer is shown, for convenience, the computer functions relating to the present teachings as described herein may be implemented in a distributed fashion on a number of similar platforms, to distribute the processing load.

The computer 2700, for example, includes COM ports 2750 connected to and from a network connected thereto to facilitate data communications. The computer 2700 also includes a central processing unit (CPU) 2720, in the form of one or more processors, for executing program instructions. The exemplary computer platform includes an internal communication bus 2710, program storage and data storage of different forms, e.g., disk 2770, read only memory (ROM) 2730, or random access memory (RAM) 2740, for various data files to be processed and/or communicated by the computer, as well as possibly program instructions to be executed by the CPU. The computer 2700 also includes an I/O component 2760, supporting input/output flows between the computer and other components therein such as user interface element. The computer 2700 may also receive programming and data via network communications.

Hence, aspects of the methods of the present teachings, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other enhanced ad server into the hardware platform(s) of a computing environment or other system implementing a computing environment or similar functionalities in connection with the present teachings. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the present teachings as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on a computer having at least one processor, a storage, and a communication platform for providing information about a product, comprising:
receiving, by a device of a user via a wireless connection when the device is near the product, a unique identifier from a near field communication (NFC) chip embedded in a tag attached to the product, wherein the tag is constructed to embed an antenna, which breaks down upon a force being applied to tear the tag, and disables communication between the NFC chip and the device;
forwarding the unique identifier to a server that stores information about the product;
receiving from the server the information about the product; and
presenting the information about the product on the device to the user.

2. The method of claim 1, wherein the tag includes a multi-layered construct, and the NFC chip and the antenna are disposed in a layer of the multi-layered construct.

3. The method of claim 1, wherein the tag has a multi-layered construct that includes a release paper layer, a first fragile paper adhesive layer, a first fragile paper layer, a double adhesive layer, a layer with the embedded antenna with the NFC chip, a second fragile paper adhesive layer, and a second fragile paper layer with a quick response (QR) code thereon.

4. The method of claim 1, wherein NFC chip stores other information to be used for authenticating the product.

5. The method of claim 1, further comprising authenticating, via communication with the server and the NFC chip, the product based on the unique identifier.

6. The method of claim 5, wherein the step of authenticating comprises:
receiving a passcode from the server, wherein the passcode is provided based on the unique identifier;
forwarding the passcode to the NFC chip via the wireless connection; and
receiving, from the NFC chip, an authentication code which is provided upon a conformation that the passcode from the server matches a corresponding passcode stored in the NFC chip;
forwarding the authentication code received from the NFC chip to the server so that the authentication code from the NFC chip is compared with a stored authentication code in the server that corresponds to the unique identifier and the passcode from the sever, wherein
the information about the product is provided by the server when the authentication code from the NFC chip matches the stored authentication code on the server.

7. The method of claim 1, further comprising providing information associated with a location of the device to the server as an estimate of a product distribution location.

8. A method implemented on a computer having at least one processor, a storage, and a communication platform for providing information about a product, comprising:
receiving a unique identifier from a device, which obtains the unique identifier from a near field communication (NFC) chip embedded in a tag attached to the product, wherein the tag has a multi-layered construct and embeds an antenna, which breaks down upon a force being applied to tear the tag, preventing the NFC chip from communicating via a wireless connection;
receiving from the device additional information associated with the device;
retrieving, based on the unique identifier, information previously stored about the product;
sending the information about the product to the device; and
recording the information associated with the device in connection with the information about the product.

9. The method of claim 8, wherein the information associated with the device includes a location of the device, which approximates a location of the product.

10. The method of claim 8, further comprising:
authenticating, via communication with the device, the product based on the unique identifier, wherein the information about the product is sent to the device upon a successful authentication of the product.

11. The method of claim 10, wherein the step of authenticating comprises:
retrieving a previously stored passcode corresponding to the received unique identifier;
sending the retrieved passcode to the device;
receiving an authentication code from the device, upon the retrieved passcode is determined to match a corresponding passcode stored in the NFC chip of the tag, wherein the received authentication code is stored in the NFC chip;
retrieving a corresponding authentication code previously stored with respect to both the unique identifier and the retrieved passcode; and
recording a successful authentication when the retrieved corresponding authentication code matches the received authentication code.

12. The method of claim 11, further comprising recording a failed authentication when the retrieved corresponding authentication code does not match the received authentication code.

13. The method of claim 8, further comprising analyzing information recorded with respect to a plurality of unique identifiers received from a plurality of devices to generate information related to distributions of one or more products.

14. The method of claim 13, further comprising:
receiving a request for the information related to a distribution of one of the one or more products;
providing information related to the distribution of the product in response to the request.

15. An apparatus comprising:
a product;
a tag attached to the product, wherein
the tag has a multi-layered construct with an embedded antenna and a near field communication (NFC) chip that is configured to communicate through the antenna,
the antenna breaks down upon a force being applied to tear the tag, preventing the NFC chip from the communication,
the NFC chip stores a plurality pieces of information and includes a processor configured to:
transmit a unique identifier stored therein to a device via a wireless connection when the device is nearby,
receive, via the wireless connection, a passcode from the device, and
transmit an authentication code stored therein when the received passcode matches a corresponding passcode stored.

16. The apparatus of claim 15, wherein the multi-layered construct includes a release paper layer, a first fragile paper adhesive layer, a first fragile paper layer, a double adhesive layer, a layer with the embedded antenna with the NFC chip, a second fragile paper adhesive layer, and a second fragile paper layer with a quick response (QR) code thereon.

17. The apparatus of claim 16, wherein a first fragile paper in the first fragile paper layer is adequately strong to endure a manufacturing process yet easily breakable when a force is used to tear the tag.

18. The apparatus of claim 16, wherein a second fragile paper in the second fragile paper layer is adequately strong to endure a manufacturing process yet easily breakable when a force is used to tear the tag.

19. The apparatus of claim 15, wherein the plurality pieces of information stored in the NFC chip in the tag are to be used for authenticating the product.

20. The apparatus of claim 15, wherein the antenna includes an extension portion, which is affixed with respect to a position on the product to detect tampering.
